(19) United States
(12) Patent Application Publication
(10) Pub. No.: US 2026/0302417 A1
(43) Pub. Date: Oct. 1, 2026

(54) PACK FRAME BASE, BATTERY CELL ASSEMBLY STRUCTURE, AND BATTERY PACK INCLUDING THE SAME

(71) Applicant: SK ON CO., LTD., Seoul (KR)

(72) Inventors: Seung Hun LEE, Daejeon (KR); Seung Il KWAK, Daejeon (KR); Sol San SON, Daejeon (KR)

(21) Appl. No.: 19/575,927

(22) Filed: Mar. 24, 2026

(30) Foreign Application Priority Data
Mar. 25, 2025 (KR) 10-2025-0038122

(51) Int. Cl. H01M 10/6556; H01M 10/613; H01M 10/625; H01M 10/647; H01M 10/6567; H01M 50/211; H01M 50/249; H01M 50/503; B60L 50/60

(52) U.S. Cl. CPC H01M 10/6556; H01M 10/613; H01M 10/625; H01M 10/647; H01M 10/6567; H01M 50/211; H01M 50/249; H01M 50/503; B60L 50/60; H01M 2220/20

(57) ABSTRACT

Disclosed are a pack frame base, a battery cell assembly structure, and a battery pack including the same. According to an embodiment of the present disclosure, the pack frame base includes: a bottom frame including a bottom plate that defines a lower face and a stud coupled to the bottom plate; and a side frame protruding upward from at least a portion of a periphery of the bottom frame, wherein the stud may include: a stud wing having a lower face that faces and contacts the bottom plate; a stud leg extending downward from the lower face of the stud wing and coupled to the bottom plate; and a stud head protruding upward from an upper face of the stud wing.

### CROSS-REFERENCE TO RELATED APPLICATION

This patent application claims the priority and benefits of Korean patent application No. 10-2025-0038122, filed on Mar. 25, 2025 the disclosure of which is incorporated herein by reference in its entirety.

### BACKGROUND OF THE INVENTION

### 1. FIELD OF THE INVENTION

The present disclosure relates to a pack frame base, a battery cell assembly structure, and a battery pack including the pack frame base and the battery cell assembly structure.

### 2. DESCRIPTION OF THE RELATED ART

A battery pack including secondary batteries may be installed in an electric vehicle or the like. A cell-to-pack method, in which the secondary batteries are directly mounted on a pack frame, may be advantageous in terms of space efficiency of the battery pack.

### SUMMARY OF THE INVENTION

According to an aspect of the present disclosure, an object of the present disclosure is to provide a pack frame base having a structure that facilitates mounting of secondary batteries on a pack frame, a battery cell assembly structure, and a battery pack including the pack frame base and the battery cell assembly structure.

A pack frame base according to the present disclosure may include: a bottom frame including a bottom plate that defines a lower face and a stud coupled to the bottom plate; and a side frame protruding upward from at least a portion of a periphery of the bottom frame, wherein the stud may include: a stud wing having a lower face that faces and contacts the bottom plate; a stud leg extending downward from the lower face of the stud wing and coupled to the bottom plate; and a stud head protruding upward from an upper face of the stud wing.

The bottom plate may include: a bottom plate body that defines a lower face of the bottom frame; and a bottom plate stud hole formed in a recessed shape in an upper face of the bottom plate body.

The stud leg may be inserted into the bottom plate stud hole and fastened thereto.

The side frame may include: a side stand protruding from the bottom plate; and a side wall extending from an upper face of the side stand and forming a step.

The pack frame base may include: as the side frame, a rear side frame protruding upward from a rear end portion of the bottom plate; a first side frame extending forward from a first end of the rear end portion of the bottom plate; and a second side frame extending forward from a second end of the rear end portion of the bottom plate.

The bottom plate may include: a cooling plate including a cooling plate body that defines the upper face of the bottom plate and a cooling channel formed in the cooling plate body; and a protective plate including a protective plate body located below the cooling plate body.

The cooling plate may include a cooling plate stud hole formed in the cooling plate body and extending vertically therethrough, and the protective plate may include a protective plate stud hole formed in the protective plate body and extending vertically therethrough, the protective plate stud hole being located below the cooling plate stud hole.

The bottom plate may further include: a cooling plate stud fastening part located between the cooling plate body and the protective plate body and coupled to the stud leg; and a protective plate stud fastening part located below a protective plate dome formed in a recessed shape in a lower face of the protective plate body and coupled to the stud leg.

A battery cell assembly structure according to the present disclosure may include: a plurality of battery cells sequentially disposed in a front-rear direction; a front cross frame located in front of the plurality of battery cells; a rear cross frame located behind the plurality of battery cells; and a busbar unit including a busbar support that connects an end of the front cross frame to an end of the rear cross frame.

The front cross frame may include: a front cross wall having a rear face that faces the frontmost battery cell among the plurality of battery cells; and a cross bottom including a cross bottom body protruding forward from the front cross wall and having an upper end that is lower than the upper end of the front cross wall.

The cross bottom may include a cross bottom stud fastening hole extending vertically through the cross bottom body.

The rear cross frame may include: a rear cross wall having a front face that faces the rearmost battery cell among the plurality of battery cells; and a cross rack including a cross rack body that protrudes rearward from the rear cross wall and has a lower end that is higher than the lower end of the rear cross wall.

The busbar support may include: a busbar support plate having a shape extending in the front-rear direction; and a pair of busbar support couplers connected to a front end and a rear end of the busbar support plate, wherein one of the pair of busbar support couplers may be coupled to the front cross wall, and the other of the pair of busbar support couplers may be coupled to the rear cross wall.

A battery pack according to the present disclosure may include: a battery cell assembly structure including a plurality of battery cells sequentially disposed in a front-rear direction, a front cross frame located in front of the plurality of battery cells, and a rear cross frame located behind the plurality of battery cells; a bottom frame including a bottom plate on which the plurality of battery cells are mounted and a stud coupled to the bottom plate; and a side frame protruding upward from at least a portion of a periphery of the bottom plate; wherein the stud may protrude upward from the bottom plate and may be coupled to the battery cell assembly structure.

The stud may include: a stud wing having a lower face that faces and contacts the bottom plate; a stud leg extending downward from the lower face of the stud wing and coupled to the bottom plate; and a stud head protruding upward from an upper face of the stud wing and coupled to the front cross frame.

The front cross frame may include: a front cross wall having a rear face that faces the frontmost battery cell among the plurality of battery cells; and a cross bottom including a cross bottom body protruding forward from the front cross wall and having an upper end that is lower than the upper end of the front cross wall, wherein the stud head may be coupled to the cross bottom.

The rear cross frame may include: a rear cross wall having a front face that faces the rearmost battery cell among the plurality of battery cells; and a cross rack including a cross rack body that protrudes rearward from the rear cross wall and has a lower end that is higher than the upper end of the cross bottom body.

The battery pack may further include, as the battery cell assembly structure, a rear battery cell assembly structure and a front battery cell assembly structure sequentially disposed from rear to front, and the cross rack of the front battery cell assembly structure may be located above and coupled to the cross bottom of the rear battery cell assembly structure.

The battery pack may further include, as the side frame, a rear side frame protruding upward from a rear end portion of the bottom plate; a first side frame extending forward from a first end of the rear end portion of the bottom plate; and a second side frame extending forward from a second end of the rear end portion of the bottom plate, wherein the cross rack body of the rear battery cell assembly structure may be coupled to the rear side frame.

The side frame may include: a side stand protruding from the bottom plate; and a side wall extending from an upper face of the side stand and forming a step, wherein the cross rack body of the rear battery cell assembly structure may be coupled to the side stand of the rear side frame.

According to an embodiment of the present disclosure, there may be provided a pack frame base having a structure that facilitates mounting of secondary batteries on a pack frame, a battery cell assembly structure, and a battery pack including the pack frame base and the battery cell assembly structure.

The pack frame base, the battery cell assembly structure, and the battery pack including the pack frame base and the battery cell assembly structure of the present disclosure may be used in eco-friendly electric vehicles and hybrid vehicles to suppress emission of air pollutants and greenhouse gases, thereby contributing to mitigation of climate change.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a perspective view illustrating a pack frame base according to an embodiment of the present disclosure;

FIG. 2 is an exploded perspective view of the pack frame base shown in FIG. 1;

FIG. 3 is a perspective view illustrating a stud according to an embodiment of the present disclosure;

FIGS. 4 and 5 are perspective views illustrating the stud coupled to a cooling plate shown in FIG. 2, viewed from different directions;

FIGS. 6 and 7 are perspective views illustrating a protective plate shown in FIG. 2, viewed from different directions;

FIG. 8 is an exploded perspective view of a bottom frame shown in FIG. 1;

FIG. 9 is a cross-sectional view of a portion of the bottom frame shown in FIG. 1;

FIG. 10 is a perspective view illustrating a battery cell assembly according to an embodiment of the present disclosure;

FIG. 11 is an exploded perspective view illustrating a battery cell assembly structure according to an embodiment of the present disclosure;

FIGS. 12 and 13 are perspective views illustrating a front cross frame viewed from different directions;

FIGS. 14 and 15 are perspective views illustrating a rear cross frame viewed from different directions;

FIGS. 16 and 17 are perspective views illustrating the battery cell assembly structure shown in FIG. 11 in an assembled state, viewed from different directions;

FIG. 18 is a perspective view illustrating the battery cell assembly structure shown in FIG. 16 being coupled to the pack frame base shown in FIG. 1;

FIG. 19 is a perspective view illustrating the pack frame of the battery pack shown in FIG. 18;

FIG. 20 is an exploded perspective view illustrating a top frame added to the pack frame shown in FIG. 18;

FIG. 21 is a perspective view illustrating a top bracket coupler shown in FIG. 20;

FIG. 22 is a perspective view illustrating the battery pack shown in FIG. 20 in an assembled state;

FIG. 23 is a cross-sectional view of the battery pack shown in FIG. 22 taken along line A1-A2;

FIG. 24 is a cross-sectional view of the battery pack shown in FIG. 22 taken along line B1-B2;

FIG. 25 is an enlarged cross-sectional view of a portion of the battery pack shown in FIG. 24;

FIG. 26 is a cross-sectional view of the battery pack shown in FIG. 22 taken along line C1-C2;

FIG. 27 is an enlarged cross-sectional view of a portion of the battery pack shown in FIG. 26;

FIG. 28 is a flowchart illustrating a first battery pack assembly method according to an embodiment of the present disclosure;

FIG. 29 is a flowchart illustrating a method for assembling the battery cell assembly structure shown in FIG. 28;

FIG. 30 is a flowchart illustrating a second battery pack assembly method according to an embodiment of the present disclosure; and

FIG. 31 is a flowchart illustrating a method for assembling a pack frame shown in FIG. 30.

### DETAILED DESCRIPTION OF THE INVENTION

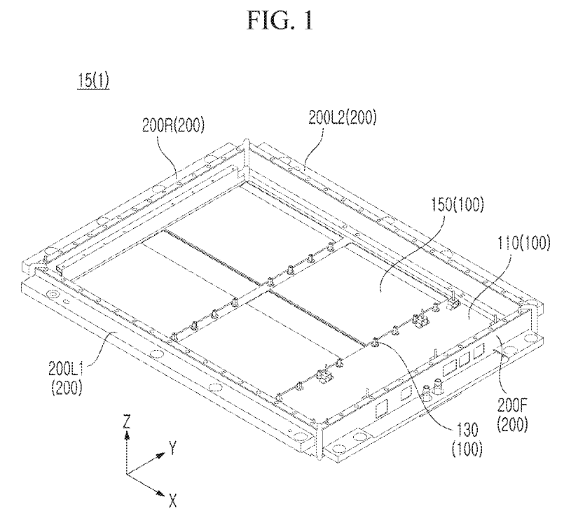

Hereinafter, the present disclosure will be described in detail with reference to FIGS. 1 -31. However, these are merely illustrative, and the present disclosure is not limited to the specific embodiments described as examples.

An XYZ coordinate system may be used in this specification. The XYZ coordinate system may be a Cartesian coordinate system.

For example, the Z-axis may be parallel to the vertical direction. For instance, a positive Z-axis direction may represent the upward direction, and a negative Z-axis direction may represent the downward direction.

For example, the X-axis may be parallel to the front-rear direction. For instance, a positive X-axis direction may represent the forward direction, and a negative X-axis direction may represent the rearward direction.

For example, the Y-axis may be parallel to the left-right direction. For instance, a positive Y-axis may represent the leftward direction, and a negative Y-axis may represent the rightward direction. For example, a negative Y-axis may refer to “a first side” or “a first direction.” For example, a positive Y-axis may refer to “a second side” or “a second direction.”

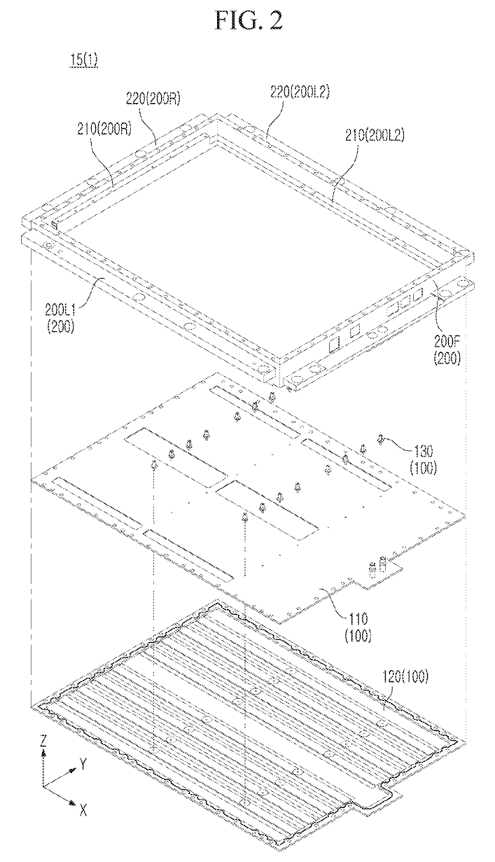

FIG. 1 is a perspective view illustrating a pack frame base according to an embodiment of the present disclosure. FIG. 2 is an exploded perspective view of the pack frame base shown in FIG. 1.

Referring to FIGS. 1 and 2, a battery pack 1 according to an embodiment of the present disclosure may include a pack frame base 15. The pack frame base 15 may form a space that is open upward.

The pack frame base 15 may be installed in at least one of an electric vehicle, a drone and a ship. For example, the pack frame base 15 may be included in at least one of a vehicle powered by electricity, a drone and a ship.

The pack frame base 15 may include a bottom frame 100. The bottom frame 100 may define the bottom of the pack frame base 15. For example, a lower face of the bottom frame 100 may define a lower face of the pack frame base 15.

For example, the bottom frame 100 may include a protective plate 120 that defines the lower face of the bottom frame 100. The protective plate 120 may have a plate or board shape. The bottom plates 110 and 120 may include or refer to at least one of a cooling plate 110 and the protective plate 120.

For example, a lower face of the protective plate 120 may define the lower face of the bottom frame 100. For example, the protective plate 120 may have four edges.

The protective plate 120 may provide rigidity to the bottom frame 100. For example, the protective plate 120 may be formed of a material including at least one of metal, reinforced plastic, and carbon nanotubes (CNTs).

The bottom frame 100 may include the cooling plate 110 that defines the upper face of the bottom frame 100. The cooling plate 110 may have a plate or board shape.

A shape of the cooling plate 110 may correspond to the shape of the protective plate 120. The cooling plate 110 may be coupled to the protective plate 120 or may face the protective plate 120. For example, a lower face of the cooling plate 110 may face an upper face of the protective plate 120.

For example, a front edge of the cooling plate 110 may be located above a front edge of the protective plate 120. The front edge of the cooling plate 110 and the front edge of the protective plate 120 may define a front edge of the bottom frame 100.

For example, a rear edge of the cooling plate 110 may be located above a rear edge of the protective plate 120. The rear edge of the cooling plate 110 and the rear edge of the protective plate 120 may define a rear edge of the bottom frame 100.

For example, a first edge of the cooling plate 110 may be located above a first edge of the protective plate 120. The first edge of the cooling plate 110 and the first edge of the protective plate 120 may define a first edge of the bottom frame 100.

The first edge of the bottom frame 100 may extend backward from a first end of the front edge of the bottom frame 100 to a first end of the rear edge of the bottom frame 100.

For example, a second edge of the cooling plate 110 may be located above a second edge of the protective plate 120. The second edge of the cooling plate 110 and the second edge of the protective plate 120 may define a second edge of the bottom frame 100.

The second edge of the bottom frame 100 may extend backward from a second end of the front edge of the bottom frame 100 to a second end of the rear edge of the bottom frame 100. The second edge of the bottom frame 100 may be located opposite the first edge of the bottom frame 100.

The cooling plate 110 may have a cooling channel formed therein. For example, a coolant may flow through the cooling plate 110. Accordingly, heat exchange may occur between the battery cells located on an upper face of the cooling plate 110 and the coolant.

The pack frame base 15 may include a side frame 200. The side frame 200 may be coupled or connected to the bottom frame 100. For example, the side frame 200 may have a shape extending upward from each edge of the bottom frame 100.

For example, the pack frame base 15 may include a front side frame 200F. The front side frame 200F may define a front face of the pack frame base 15.

The front side frame 200F may be coupled or connected to the front edge or front end portion of the bottom frame 100. For example, the front side frame 200F may have a shape extending upward from the front edge of the bottom frame 100.

For example, the pack frame base 15 may include a rear side frame 200R. The rear side frame 200R may define a rear face of the pack frame base 15.

The rear side frame 200R may be coupled or connected to the rear edge or rear end portion of the bottom frame 100. For example, the rear side frame 200R may have a shape extending upward from the rear edge of the bottom frame 100.

For example, the pack frame base 15 may include a first side frame 200L1. The first side frame 200L1 may define a first lateral face of the pack frame base 15.

The first side frame 200L1 may be coupled or connected to the first edge of the bottom frame 100. For example, the first side frame 200L1 may have a shape extending upward from the first edge of the bottom frame 100.

For example, the pack frame base 15 may include a second side frame 200L2. The second side frame 200L2 may define a second lateral face of the pack frame base 15.

The second side frame 200L2 may be coupled or connected to the second edge of the bottom frame 100. For example, the second side frame 200L2 may have a shape extending upward from the second edge of the bottom frame 100.

A lateral side of the bottom frame 100 may include or refer to at least one of the first edge and the second edge of the bottom frame 100. For example, the lateral side of the bottom frame 100 may extend backward from the front end portion of the bottom frame 100 to the rear end portion of the bottom frame 100 as a portion of an edge of the bottom frame 100.

The side frame 200 may include or refer to at least one of the front side frame 200F, the rear side frame 200R, the first side frame 200L1, and the second side frame 200L2.

For example, the lateral side frames 200L1 and 200L2 may include or refer to at least one of the first side frame 200L1 and the second side frame 200L2.

The front side frame 200F and the rear side frame 200R may have a shape extending in a width direction of the pack frame base 15. For example, the width direction of the pack frame base 15 may be parallel to the Y-axis.

A longitudinal direction of the pack frame base 15 may be parallel to the X-axis, for example. For example, a length direction of the first side frame 200L1 and a length direction of the second side frame 200L2 may correspond to the longitudinal direction of the pack frame base 15.

For example, a direction in which the front side frame 200F extends may be in the length direction of the front side frame 200F, and a direction in which the rear side frame 200R extends may be the length direction of the rear side frame 200R.

For example, the front side frame 200F may extend from a first end of the front side frame 200F to a second end of the front side frame 200F.

For example, the rear side frame 200R may extend from a first end of the rear side frame 200R to a second end of the rear side frame 200R.

The first side frame 200L1 may extend rearward from a front end of the first side frame 200L1 to a rear end of the first side frame 200L1. The front end of the first side frame 200L1 may be adjacent to or connected to the first end of the front side frame 200F. The rear end of the first side frame 200L1 may be adjacent to or connected to the first end of the rear side frame 200R.

The second side frame 200L2 may extend rearward from a front end of the second side frame 200L2 to a rear end of the second side frame 200L2. The front end of the second side frame 200L2 may be adjacent to or connected to the second end of the front side frame 200F. The rear end of the second side frame 200L2 may be adjacent to or connected to the second end of the rear side frame 200R.

The side frame 200 may include a side stand 210. The side stand 210 may be connected to or coupled to the bottom frame 100. A length direction of the side stand 210 may correspond to a length direction of the side frame 200.

For example, the length direction of the side stand 210 of the rear side frame 200R may correspond to the length direction of the rear side frame 200R. For example, the length direction of the side stand 210 of the first side frame 200L1 may correspond to the length direction of the first side frame 200L1. For example, the length direction of the side stand 210 of the second side frame 200L2 may correspond to the length direction of the second side frame 200L2.

The side frame 200 may include a side wall 220. The side wall 220 may be connected or coupled to the side stand 210. For example, the side wall 220 may have a shape extending from the side stand 210.

The side wall 220 may have a shape extending in a length direction of the side wall 220. The side wall 220 and the side stand 210 may form a step.

For example, at least a portion of the side wall 220 may extend upward from an upper face of the side stand 210. For example, the upper face of the bottom frame 100, the upper face of the side stand 210, and the upper face of the side wall 220 may sequentially form a step.

For example, the side wall 220 may define an outer surface of the side frame 200. For example, the side wall 220 of the rear side frame 200R may be located behind the side stand 210 of the rear side frame 200R.

For example, the side stand 210 of the first side frame 200L1 and the side stand 210 of the second side frame 200L2 may be located between the side wall 220 of the first side frame 200L1 and the side wall 220 of the second side frame 200L2.

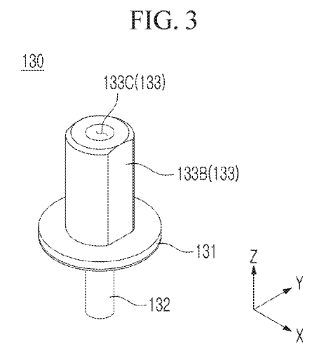

FIG. 3 is a perspective view illustrating a stud according to an embodiment of the present disclosure.

Referring to FIGS. 1 -3, the bottom frame 100 may include a stud 130. The stud 130 may include a stud wing 131. The stud wing 131 may have two surfaces. For example, the stud wing 131 may have an upper face and a lower face.

The stud 130 may include a stud leg 132. The stud leg 132 may be coupled to the stud wing 131. For example, the stud leg 132 may extend downward from the stud wing 131. For example, the stud leg 132 may extend downward from a lower face of the stud wing 131.

The stud leg 132 may form a step with the stud wing 131. For example, the stud leg 132 may have a shape extending downward from a portion of the lower face of the stud wing 131.

The stud 130 may be coupled to the cooling plate 110. For example, the stud leg 132 may penetrate the cooling plate 110. For example, the lower face of the stud wing 131 may face the upper face of the cooling plate 110.

For example, the stud leg 132 may be sequentially inserted into the cooling plate 110 and the protective plate 120. For example, a lower end portion of the stud leg 132 may be observed from the lower face of the protective plate 120.

The stud 130 may include a stud head 133. For example, the stud head 133 may include a stud head body 133B. The stud head body 133B may be coupled to the stud wing 131.

For example, the stud head body 133B may extend upward from the stud wing 131. The stud head body 133B may form a step with stud wing 131. For example, the stud head body 133B may have a shape extending upward from a portion of an upper face of stud wing 131.

The stud head 133 may include a stud head coupler space 133C formed in the stud head body 133B. For example, the stud head coupler space 133C may be a hollow portion defined in the stud head body 133B.

For example, the stud head coupler space 133C may be open upward. An inner surface of the stud head body 133B may define the stud head coupler space 133C. For example, threads may be formed on the inner surface of the stud head body 133B.

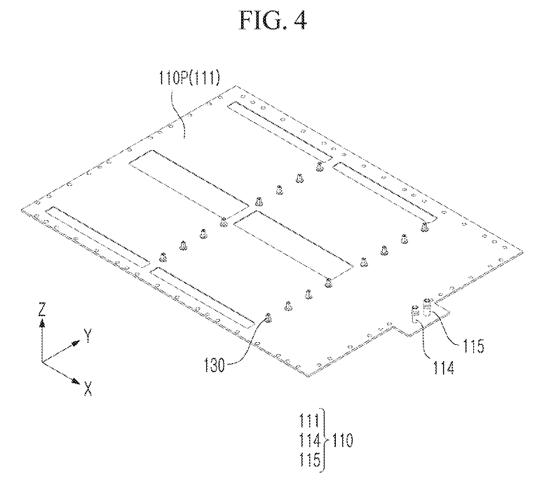

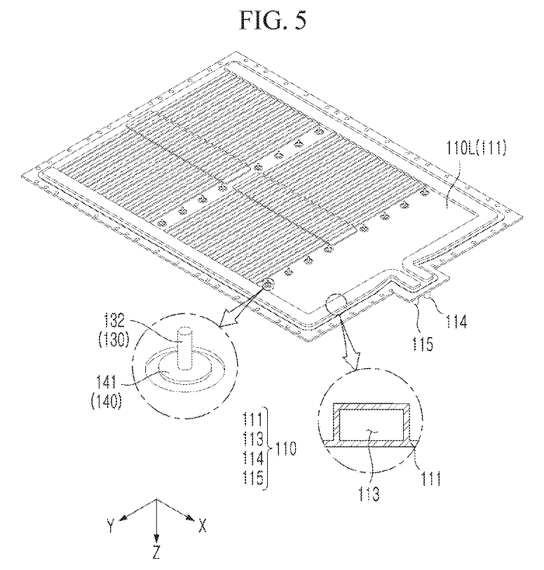

FIGS. 4 and 5 are perspective views illustrating the stud coupled to a cooling plate shown in FIG. 2, viewed from different directions.

Referring to FIGS. 3 -5, the cooling plate 110 may include a cooling plate body 111. The cooling plate body 111 may have a plate shape.

For example, the cooling plate body 111 may have two surfaces. For example, a cooling plate upper face 110P may define or represent the upper face of the cooling plate 110.

For example, a cooling plate lower face 110L may define or represent the lower face of the cooling plate 110. For example, the cooling plate lower face 110L may face the protective plate 120 (see FIG. 2).

The cooling plate 110 may include a cooling channel 113. The cooling channel 113 may be a passage formed in the cooling plate body 111. A coolant may flow through the cooling channel 113.

The cooling plate 110 may include a coolant inlet port 114. The coolant inlet port 114 may be connected to the cooling plate body 111. For example, the coolant inlet port 114 may be in communication with the cooling channel 113.

The cooling plate 110 may include a coolant outlet port 115. The coolant outlet port 115 may be connected to the cooling plate body 111. For example, the coolant outlet port 115 may be in communication with the cooling channel 113.

For example, the cooling channel 113 may extend from one end of the cooling channel 113 to the other end of the cooling channel 113. For example, one end of the cooling channel 113 may be connected to the coolant inlet port 114, and the other end of the cooling channel 113 may be connected to the coolant outlet port 115.

For example, a coolant may be introduced into the coolant inlet port 114. The coolant introduced into the coolant inlet port 114 may flow through the cooling channel 113. The coolant flowing through the cooling channel 113 may be discharged to the outside through the coolant outlet port 115.

The stud 130 may be coupled to the cooling plate 110. For example, the lower face of the stud wing 131 may face or contact the cooling plate upper face 110P.

For example, the stud leg 132 may penetrate a hole formed in the cooling plate body 111. For example, the lower end portion of the stud leg 132 may protrude downward from the cooling plate lower face 110L.

The bottom frame 100 (see FIG. 2) may include the stud fastening part 140. For example, the bottom frame 100 (see FIG. 2) may include a cooling plate stud fastening part 141.

The cooling plate stud fastening part 141 may be located below the cooling plate 110. For example, the cooling plate stud fastening part 141 may face the cooling plate lower face 110L.

The stud 130 may be fastened to the cooling plate stud fastening part 141. For example, the stud leg 132 may penetrate the cooling plate stud fastening part 141. For example, the lower end portion of the stud leg 132 may protrude downward from the cooling plate stud fastening part 141.

For example, threads may be formed on an outer surface of the stud leg 132. For example, the cooling plate stud fastening part 141 may be a threaded nut. For example, the cooling plate stud fastening part 141 and the stud leg 132 may be threadedly engaged with each other.

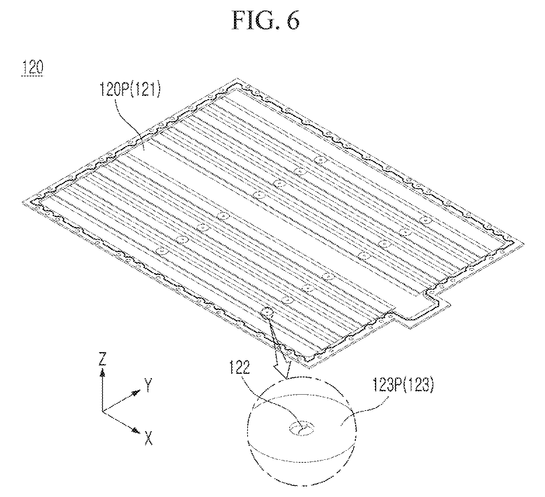

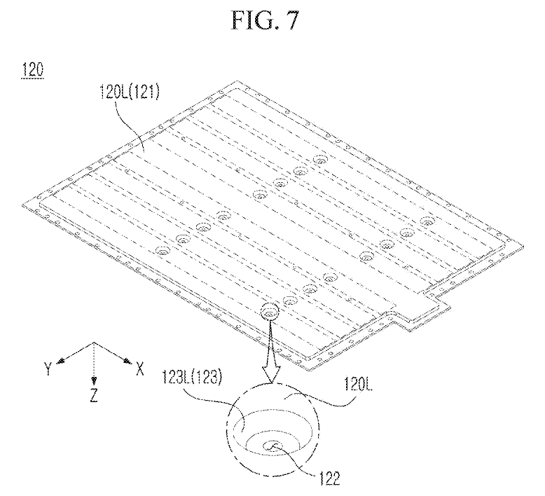

FIGS. 6 and 7 are perspective views illustrating the protective plate shown in FIG. 2, viewed from different directions.

The protective plate 120 may include a protective plate body 121. The protective plate body 121 may have a plate shape. For example, the protective plate body 121 may have two surfaces.

For example, a protective plate upper face 120P may define the upper face of the protective plate 120. For example, a protective plate lower face 120L may define the lower face of the protective plate 120.

The protective plate 120 may be located below the cooling plate 110 (see FIG. 2). For example, the protective plate upper face 120P may face the cooling plate lower face 110L (see FIG. 5).

The protective plate 120 may include a protective plate dome 123. For example, the protective plate dome 123 may be formed in the protective plate body 121 in a dome shape.

The protective plate dome 123 may include or refer to at least one of a protective plate upper dome 123P and a protective plate lower dome 123L. For example, the protective plate upper dome 123P may protrude from the protective plate upper face 120P. For example, the protective plate lower dome 123L may be recessed in the protective plate lower face 120L.

The protective plate 120 may include a protective plate stud hole 122. The protective plate stud hole 122 may be a hole formed in at least one of the protective plate body 121 and the protective plate dome 123. For example, the protective plate stud hole 122 may be a hole formed in the protective plate dome 123.

Referring to FIGS. 1 -7, the bottom plate bodies 111 and 121 may include or refer to at least one of the cooling plate body 111 and the protective plate body 121.

The bottom plate stud holes 112 and 122 may include or refer to at least one of a cooling plate stud hole 112 and the protective plate stud hole 122.

The bottom plate stud holes 112 and 122 may be holes formed in the bottom plate bodies 111 and 121, or may be concave portions formed in the upper faces of the bottom plate bodies 111 and 121.

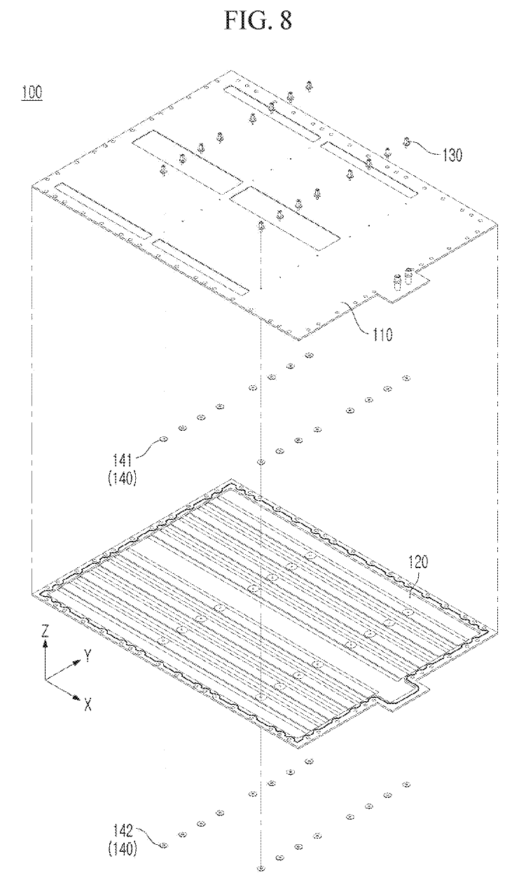

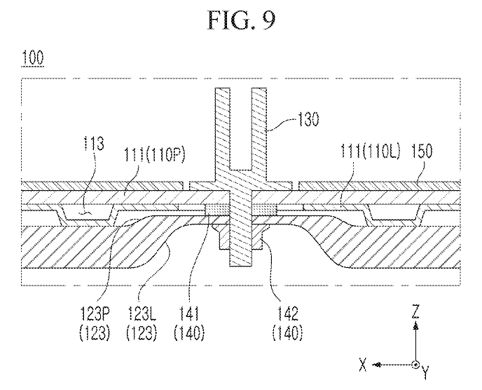

FIG. 8 is an exploded perspective view of the bottom frame shown in FIG. 1. FIG. 9 is a cross-sectional view of a portion of the bottom frame shown in FIG. 1.

Referring to FIGS. 8 and 9, the stud 130 may be coupled to the protective plate 120. For example, the lower end portion of the stud leg 132 may penetrate the cooling plate body 111 and the protective plate stud hole 122.

For example, the lower end portion of the stud leg 132 may face a lower face of the protective plate lower dome 123L. For example, the lower end portion of the stud leg 132 may protrude downward from the protective plate stud hole 122.

The stud 130 and the protective plate 120 may be coupled. For example, the bottom frame 100 may include a protective plate stud fastening part 142. The stud fastening part 140 may include or refer to at least one of the cooling plate stud fastening part 141 and the protective plate stud fastening part 142.

Threads may be formed on an inner surface of the protective plate stud fastening part 142. For example, the protective plate stud fastening part 142 may be a threaded nut.

For example, the protective plate stud fastening part 142 may be coupled to a lower end portion of the stud leg 132. For example, the protective plate stud fastening part 142 may be located below the protective plate stud hole 122.

The stud leg 132 may be sequentially inserted into the hole formed in the cooling plate body 111, the cooling plate stud fastening part 141, the protective plate stud hole 122, and the protective plate stud fastening part 142.

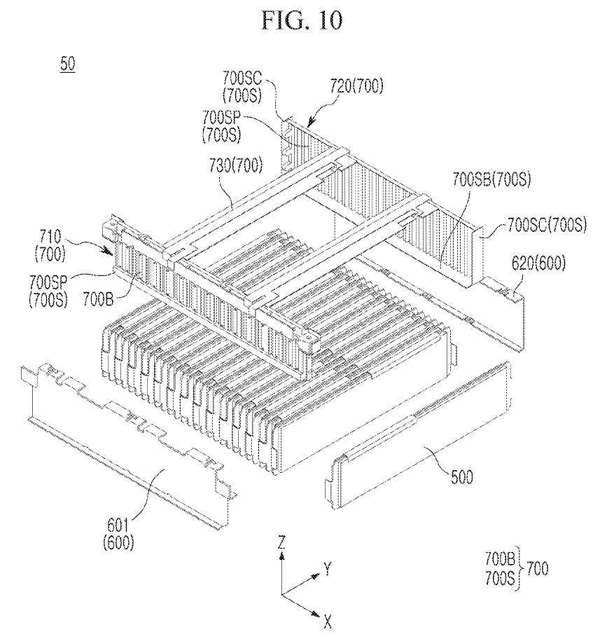

FIG. 10 is a perspective view illustrating a battery cell assembly according to an embodiment of the present disclosure.

Referring to FIG. 10, a battery cell assembly 50 may include at least one battery cell 500. For example, the battery cell assembly 50 may include a plurality of battery cells 500.

The plurality of battery cells 500 may be stacked in one direction. For example, a direction in which the plurality of battery cells 500 are stacked or disposed may correspond to the longitudinal direction of the pack frame base 15 (see FIG. 1).

For example, a longitudinal direction of the battery cell assembly 50 may be the direction in which the plurality of battery cells 500 are disposed. For example, the longitudinal direction of the battery cell assembly 50 may correspond to the longitudinal direction of the pack frame base 15 (see FIG. 1).

For example, a width direction or a transverse direction of the battery cell assembly 50 may correspond to a length direction of one battery cell 500.

For example, the width direction or the transverse direction of the battery cell assembly 50 may be parallel to a direction from a first side cover 601 toward a second side cover 602.

For example, the width direction or the transverse direction of the battery cell assembly 50 may be parallel to a direction from a first busbar unit 710 toward a second busbar unit 720.

The battery cell 500 may include an electrode assembly (not shown). The battery cell 500 may include a member that encloses the electrode assembly (not shown). The type of battery cell 500 may vary depending on the member that encloses the electrode assembly (not shown).

For example, the battery cell 500 may include a hexahedral case (not shown) that accommodates the electrode assembly (not shown). In this case, the battery cell 500 may be referred to as a “prismatic battery cell.”

For example, the battery cell 500 may include a cylindrical case (not shown) that accommodates the electrode assembly (not shown). In this case, the battery cell 500 may be referred to as a “cylindrical battery cell.”

For example, the battery cell 500 may include a pouch (not shown) that encloses the electrode assembly (not shown). In this case, the battery cell 500 may be referred to as a “pouch-type battery cell.” The pouch (not shown) may be flexible and have a sheet shape. In this specification, the battery cell 500 is exemplified as a pouch-type battery cell, but the present disclosure is not limited thereto.

The battery cell assembly 50 may include a busbar assembly 700. The busbar assembly 700 may include busbar units 710 and 720. The busbar units 710 and 720 may include or refer to at least one of a first busbar unit 710 and a second busbar unit 720.

A length direction of the busbar units 710 and 720 may correspond to the longitudinal direction of the battery cell assembly 50. For example, the busbar units 710 and 720 may have a shape extending in the length direction of the busbar units 710 and 720.

For example, the busbar units 710 and 720 may electrically connect the plurality of battery cells 500. For example, the first busbar unit 710 may be connected to a first side of the plurality of battery cells 500. For example, the second busbar unit 720 may be connected to a second side of the plurality of battery cells 500.

The battery cell 500 may extend from a first end of the battery cell 500 to a second end of the battery cell 500. The first end of the battery cell 500 may be located on the first side of the plurality of battery cells 500. The second end of the battery cell 500 may be located on the second side of the plurality of battery cells 500.

For example, the first busbar unit 710 may be connected to the first end of the battery cell 500. For example, the second busbar unit 720 may be connected to the second end of the battery cell 500.

The busbar units 710 and 720 may include a busbar 700B. For example, the busbar 700B may be electrically connected to the battery cells 500. For example, the plurality of busbars 700B may be disposed in the longitudinal direction of the battery cell assembly 50.

The busbar units 710 and 720 may include a busbar support 700S. The busbar support 700S may support the busbar 700B. For example, the busbar support 700S may be formed of a material including an electrically insulating material.

The busbar units 710 and 720 may include a busbar support plate 700SP. The busbar support plate 700SP may have a plate shape. The busbar 700B may be coupled to an outer surface of the busbar support plate 700SP.

For example, the busbar support plate 700SP may have a shape extending in the length direction of the busbar support plate 700SP. For example, the length direction of the busbar support plate 700SP may correspond to the longitudinal direction of the battery cell assembly 50.

The busbar units 710 and 720 may include a busbar support base 700SB. The busbar support base 700SB may be coupled or connected to the busbar support plate 700SP.

For example, the busbar support base 700SB may be coupled or connected to a lower end portion of the busbar support plate 700SP. For example, the busbar support base 700SB may extend from the lower end portion of the busbar support plate 700SP.

For example, the busbar support base 700SB of the first busbar unit 710 may extend or protrude from the lower end portion of the busbar support plate 700SP of the first busbar unit 710 toward the second busbar unit 720.

For example, the busbar support base 700SB of the second busbar unit 720 may extend or protrude from the lower end portion of the busbar support plate 700SP of the second busbar unit 720 toward the first busbar unit 710.

The busbar support base 700SB may support the battery cell 500. For example, the busbar support base 700SB may support an end of the battery cell 500.

For example, the busbar support base 700SB of the first busbar unit 710 may be located below the first end of the battery cell 500. For example, the busbar support base 700SB of the first busbar unit 710 may support the first end of the battery cell 500.

For example, the busbar support base 700SB of the second busbar unit 720 may be located below the second end of the battery cell 500. For example, the busbar support base 700SB of the second busbar unit 720 may support the second end of the battery cell 500.

The busbar units 710 and 720 may include a busbar support coupler 700SC. The busbar support coupler 700SC may be connected or coupled to an end of the busbar support plate 700SP.

For example, the busbar support coupler 700SC may extend from an end of the busbar support plate 700SP. For example, the busbar support coupler 700SC may extend from a front end of the busbar support plate 700SP. For example, the busbar support coupler 700SC may extend from a rear end of the busbar support plate 700SP.

The busbar support 700S may include or refer to at least one of the busbar support plate 700SP, the busbar support base 700SB, and the busbar support coupler 700SC.

The busbar assembly 700 may include a busbar connector 730. One end of the busbar connector 730 may be connected to the first busbar unit 710, and the other end of the busbar connector 730 may be connected to the second busbar unit 720.

The busbar connector 730 may extend from one end of the busbar connector 730 to the other end of the busbar connector 730. The busbar connector 730 may obtain electrical signals from the busbar units 710 and 720.

An electrical signal generated from the battery cell 500 may be transmitted to the busbar connector 730 via the busbar units 710 and 720. The electrical signal generated from the battery cell 500 may include, for example, information regarding at least one of a voltage and a current of the battery cell 500.

The battery cell assembly 50 may include a side cover 600. The side cover 600 may include or refer to at least one of a first side cover 601 and a second side cover 602.

A length direction of the side cover 600 may correspond to the longitudinal direction of the battery cell assembly 50. For example, the length direction of the side cover 600 may correspond to the front-rear direction. For example, the side cover 600 may have a shape extending in the length direction of the side cover 600.

For example, a front end portion of the side cover 600 may face the frontmost battery cell 500 among the plurality of battery cells 500. For example, a rear end portion of the side cover 600 may face the rearmost battery cell 500 among the plurality of battery cells 500.

The side cover 600 may be coupled to or face the busbar units 710 and 720. The side cover 600 may be formed of a material including an electrically insulating material.

For example, the first side cover 601 may be coupled to or face the first busbar unit 710. For example, the busbar 700B of the first busbar unit 710 may be located between the busbar support plate 700SP of the first busbar unit 710 and the first side cover 601.

For example, the second side cover 602 may be coupled to or face the second busbar unit 720. For example, the busbar 700B of the second busbar unit 720 may be located between the busbar support plate 700SP of the second busbar unit 720 and the second side cover 602.

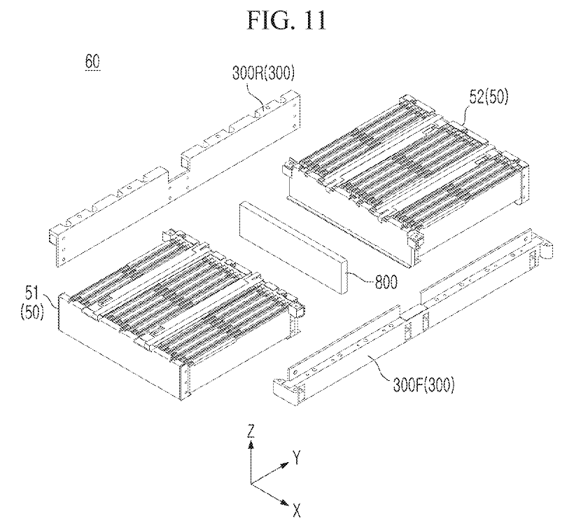

FIG. 11 is an exploded perspective view illustrating a battery cell assembly structure according to an embodiment of the present disclosure.

Referring to FIGS. 10 and 11, a battery cell assembly structure 60 may include the battery cell assembly 50. For example, the battery cell assembly structure 60 may include a plurality of battery cell assemblies 50.

For example, the battery cell assembly structure 60 may include a first battery cell assembly 51 and a second battery cell assembly 52. Each of the first battery cell assembly 51 and the second battery cell assembly 52 may be the battery cell assembly 50.

The first battery cell assembly 51 and the second battery cell assembly 52 may be disposed in a width direction of the battery cell assembly structure 60. The width direction of the battery cell assembly structure 60 may be a width direction of the first battery cell assembly 51 or a width direction of the second battery cell assembly 52.

The battery cell assembly structure 60 may include a spacer 800. The spacer 800 may be disposed between the first battery cell assembly 51 and the second battery cell assembly 52.

For example, the first battery cell assembly 51, the spacer 800, and the second battery cell assembly 52 may be sequentially disposed in the width direction of the battery cell assembly structure 60.

The spacer 800 may have a shape extending in a length direction of the spacer 800. The length direction of the spacer 800 may be the length direction or the longitudinal direction of the battery cell assembly 50. The longitudinal direction of the battery cell assembly 50 may correspond to the longitudinal direction of the battery cell assembly structure 60.

The battery cell assembly structure 60 may include a cross frame 300. A plurality of cross frames 300 may be provided. For example, the battery cell assembly structure 60 may include the plurality of cross frames 300.

For example, the battery cell assembly structure 60 may include a front cross frame 300F and a rear cross frame 300R. For example, the cross frame 300 may include or refer to at least one of the front cross frame 300F and the rear cross frame 300R.

The front cross frame 300F, the battery cell assembly 50, and the rear cross frame 300R may be disposed in the longitudinal direction of the battery cell assembly structure 60.

The battery cell assembly 50 may be located between the front cross frame 300F and the rear cross frame 300R. For example, the front cross frame 300F may be located in front of the battery cell assembly 50. For example, the rear cross frame 300R may be located behind the battery cell assembly 50.

The cross frame 300 may have a shape extending in the width direction or the transverse direction of the battery cell assembly structure 60. For example, the length direction of the cross frame 300 may correspond to the width direction or the transverse direction of the battery cell assembly structure 60.

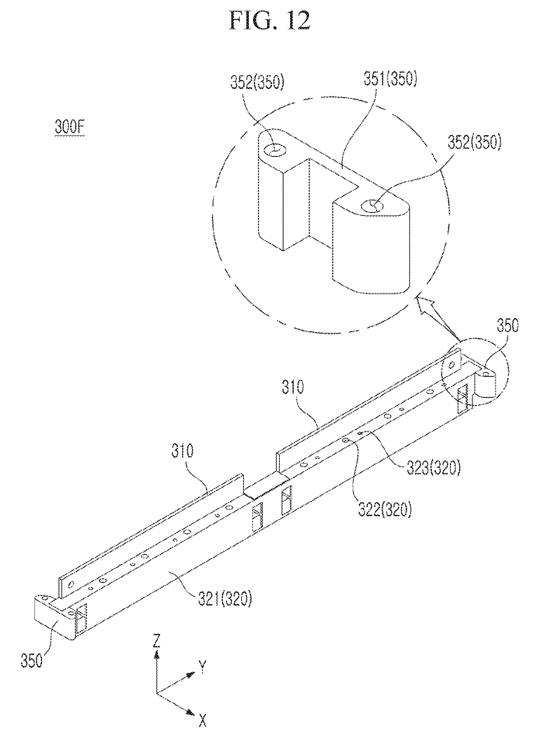

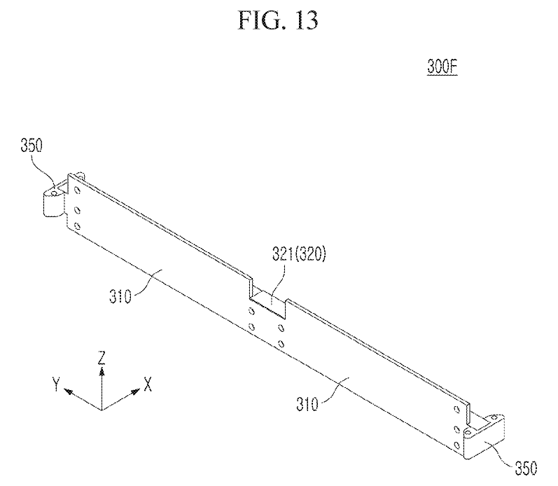

FIGS. 12 and 13 are perspective views illustrating the front cross frame viewed from different directions.

Referring to FIGS. 12 and 13, the front cross frame 300F may include a cross bottom 320. The cross bottom 320 may include a cross bottom body 321.

The cross bottom body 321 may have a shape extending in a length direction of the cross bottom body 321. For example, the cross bottom body 321 may have a beam shape. The length direction of the cross bottom body 321 may correspond to the width direction or the transverse direction of the battery cell assembly structure 60 (see FIG. 11).

The cross bottom 320 may include a cross bottom stud fastening hole 322. The cross bottom stud fastening hole 322 may be a hole formed in the cross bottom body 321. The cross bottom stud fastening hole 322 may penetrate the cross bottom body 321 in a vertical direction.

A plurality of cross bottom stud fastening holes 322 may be provided. For example, the cross bottom 320 may include the plurality of cross bottom stud fastening holes 322. The plurality of cross bottom stud fastening holes 322 may be disposed in the length direction of the cross bottom body 321.

The cross bottom 320 may include a cross bottom rack fastening hole 323. The cross bottom rack fastening hole 323 may be a hole formed in the cross bottom body 321. For example, the cross bottom rack fastening hole 323 may be formed in a recessed shape in an upper face of the cross bottom body 321.

A plurality of cross bottom rack fastening holes 323 may be provided. For example, the cross bottom 320 may include the plurality of cross bottom rack fastening holes 323. The plurality of cross bottom rack fastening holes 323 may be disposed in a length direction of the cross bottom body 321.

The front cross frame 300F may include a cross wall 310. The cross wall 310 of the front cross frame 300F may be referred to as a “front cross wall.” For example, a rear face of the front cross wall 310 may face the battery cell assembly 50 (see FIG. 11).

The front cross wall 310 may be connected or coupled to the cross bottom 320. For example, a front face of the front cross wall 310 may face or be coupled to the cross bottom 320.

For example, the cross bottom body 321 may have a shape protruding forward from the front face of the front cross wall 310. For example, the cross bottom body 321 may protrude or extend forward from the front face of the front cross wall 310.

For example, an upper end of the front cross wall 310 may be higher than the upper end of the cross bottom 320. For example, an upper end portion of the front face of the front cross wall 310 may be observed from the front face of the front cross wall 310.

The front cross frame 300F may include a cross side coupler 350. A plurality of cross side couplers 350 may be provided. For example, the front cross frame 300F may include a pair of cross side couplers 350.

The cross side coupler 350 may be coupled to an end of the cross bottom body 321. The end of the cross bottom body 321 may include or refer to at least one of a first end and a second end of the cross bottom body 321.

The cross bottom body 321 may extend from the first end of the cross bottom body 321 in the width direction of the battery cell assembly structure 60 (see FIG. 11) to the second end of the cross bottom body 321.

For example, one of the pair of cross side couplers 350 may be coupled to the first end of the cross bottom 320, and the other of the pair of cross side couplers 350 may be coupled to the second end of the cross bottom 320.

The cross side coupler 350 may include a cross side coupler body 351. The cross side coupler body 351 may have a concave groove shape.

The cross bottom body 321 may be coupled to the cross side coupler body 351. For example, an end of the cross bottom body 321 may fit into the groove formed in the cross side coupler body 351.

The cross side coupler 350 may include a cross side coupler fastening hole 352. The cross side coupler fastening hole 352 may be a hole formed in the cross side coupler body 351. For example, the cross side coupler fastening hole 352 may penetrate the cross side coupler body 351 in the vertical direction.

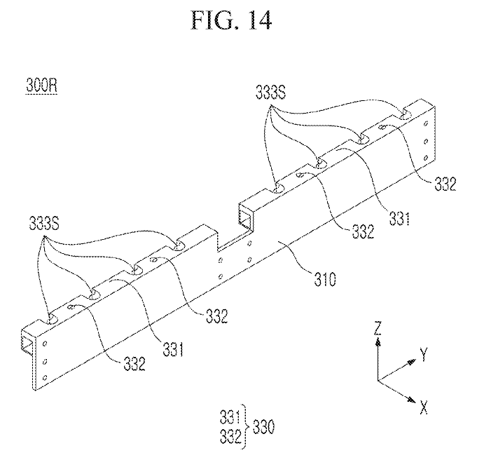

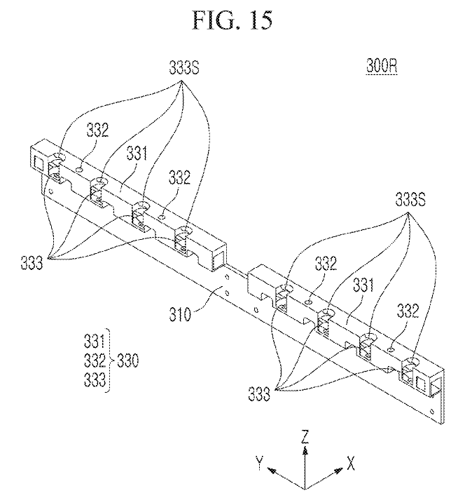

FIGS. 14 and 15 are perspective views illustrating the rear cross frame viewed from different directions.

Referring to FIGS. 14 and 15, the rear cross frame 300R may include a cross wall 310. The cross wall 310 of the rear cross frame 300R may be referred to as a “rear cross wall.”

The rear cross wall 310 may have a shape extending in the width direction or the transverse direction of the battery cell assembly structure 60 (see FIG. 11). For example, the rear cross wall 310 may have a plate shape.

The rear cross frame 300R may include a cross rack 330. The cross rack 330 may include a cross rack body 331. The cross rack body 331 may be coupled to the rear cross wall 310.

For example, the cross rack body 331 may be coupled to an upper end portion of the rear cross wall 310. For example, the cross rack body 331 may be coupled or connected to an upper end portion of a rear face of the rear cross wall 310.

For example, the cross rack body 331 may have a shape protruding rearward from the upper end portion of the rear face of the rear cross wall 310. For example, the cross rack body 331 may protrude or extend rearward from the upper end portion of the rear face of the rear cross wall 310.

The cross rack 330 may include a cross rack top fastening hole 332. The cross rack top fastening hole 332 may be a hole formed in an upper face of the cross rack body 331.

A plurality of cross rack top fastening holes 332 may be provided. For example, the cross rack 330 may include the plurality of cross rack top fastening holes 332. The plurality of cross rack top fastening holes 332 may be disposed in a length direction of the cross rack body 331.

The cross rack 330 may include a cross rack bottom fastening hole 333. The cross rack bottom fastening hole 333 may be a hole formed in a lower face of the cross rack body 331.

For example, the cross rack bottom fastening hole 333 may be observed from above the cross rack 330. For example, the cross rack bottom fastening hole 333 may be located below a cross rack working space 333S.

For example, the cross rack working space 333S may be a hole or opening formed in the upper face of the cross rack body 331. The cross rack working space 333S and the cross rack bottom fastening hole 333 may be in communication with each other.

A plurality of cross rack working spaces 333S may be provided. For example, the plurality of cross rack working spaces 333S and the plurality of cross rack top fastening holes 332 may be spaced apart from each other.

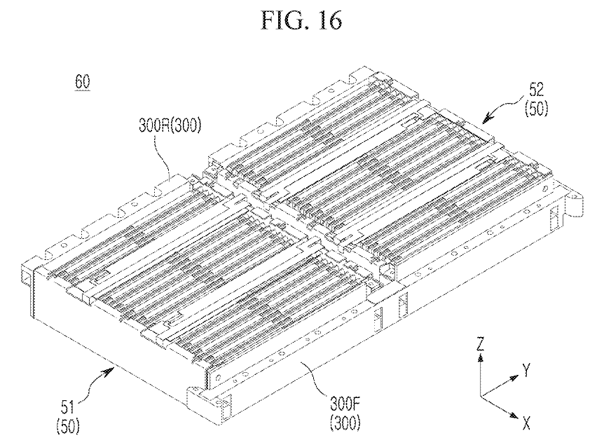

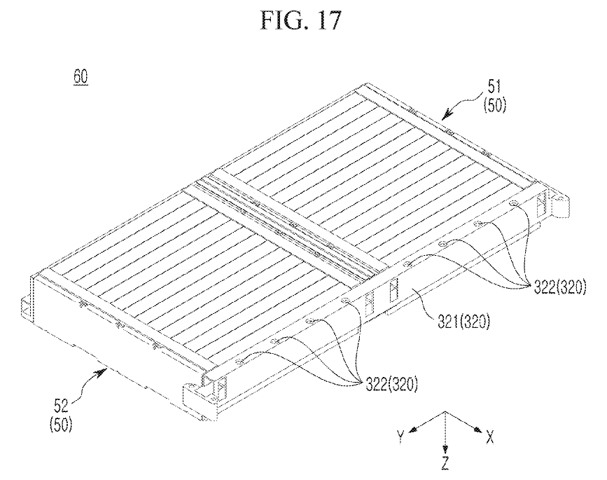

FIGS. 16 and 17 are perspective views illustrating the battery cell assembly structure shown in FIG. 11 in an assembled state, viewed from different directions.

Referring to FIGS. 10 -17, the battery cell assembly 50 may be coupled to the cross frame 300. For example, the busbar support coupler 700SC may face the cross wall 310 and be coupled to the cross wall 310. For example, the busbar support coupler 700SC and the cross wall 310 may be coupled to each other using screws or the like.

For example, among the plurality of busbar support couplers 700SC, the busbar support coupler 700SC located at a front portion of the battery cell assembly 50 may be coupled to the cross wall 310 of the front cross frame 300F.

For example, among the plurality of busbar support couplers 700SC, the busbar support coupler 700SC located at a rear portion of the battery cell assembly 50 may be coupled to the cross wall 310 of the rear cross frame 300R.

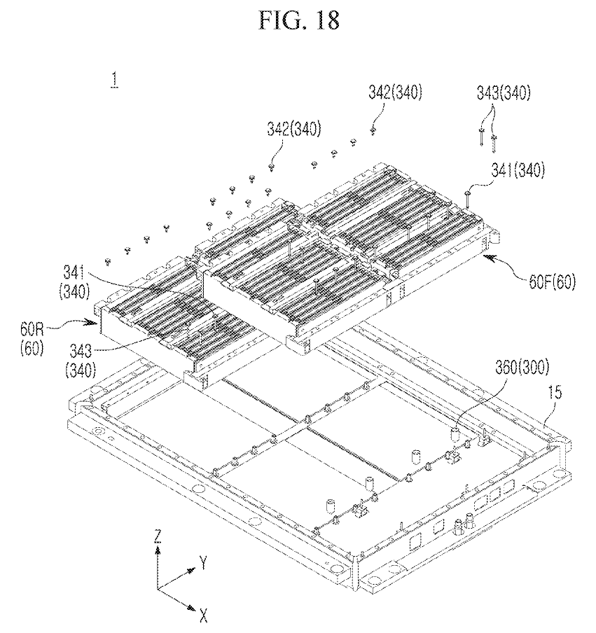

FIG. 18 is a perspective view illustrating the battery cell assembly structure shown in FIG. 16 being coupled to the pack frame base shown in FIG. 1.

Referring to FIGS. 1 -18, for example, at least one battery cell assembly structure 60 may be accommodated in the pack frame base 15 and coupled thereto. For example, a plurality of battery cell assembly structures 60 may be accommodated in the pack frame base 15 and coupled thereto.

For example, the battery cell assembly structure 60 may include or refer to at least one of a front battery cell assembly structure 60F and a rear battery cell assembly structure 60R.

For example, the cross frame 300 of the battery cell assembly structure 60 may be coupled to the bottom frame 100. For example, the cross bottom 320 may be coupled to the bottom frame 100.

For example, the cross frame 300 may include a cross fastening part 340. The cross fastening part 340 may include a stud bottom fastening part 341. The stud bottom fastening part 341 may have, for example, a bolt shape.

For example, the stud bottom fastening part 341 may couple the cross bottom 320 and the bottom frame 100. For example, the stud bottom fastening part 341 may be coupled by passing through the cross bottom stud fastening hole 322 and being inserted into the stud head 133. For example, a lower end portion of the stud bottom fastening part 341 may be accommodated and fastened in the stud head coupler space 133C.

For example, the rear battery cell assembly structure 60R may be coupled to the rear side frame 200R. For example, the rear cross frame 300R of the rear battery cell assembly structure 60R may be coupled to the side stand 210 of the rear side frame 200R.

For example, the cross rack 330 of the rear battery cell assembly structure 60R may be coupled to the side stand 210 of the rear side frame 200R.

For example, the cross fastening part 340 may include a bottom rack fastening part 342. For example, the bottom rack fastening part 342 may have a bolt shape.

For example, the bottom rack fastening part 342 may be inserted into the cross rack bottom fastening hole 333 of the rear battery cell assembly structure 60R and into the side stand 210 of the rear side frame 200R.

The cross frame 300 may be coupled to the lateral side frames 200L1 and 200L2. For example, the cross side coupler 350 may be coupled to the side stands 210 of the lateral side frames 200L1 and 200L2.

For example, the cross fastening part 340 may include a cross side fastening part 343. For example, the cross side fastening part 343 may have a bolt shape.

The cross side fastening part 343 may couple the cross side coupler 350 and the lateral side frames 200L1 and 200L2. For example, the cross side fastening part 343 may be inserted into the cross side coupler fastening hole 352 and fastened to the side stands 210 of the lateral side frames 200L1 and 200L2.

After the rear battery cell assembly structure 60R is coupled to the pack frame base 15, the front battery cell assembly structure 60F may be coupled to the pack frame base 15.

A process of coupling the front battery cell assembly structure 60F to the pack frame base 15 may include coupling the front battery cell assembly structure 60F to the rear battery cell assembly structure 60R.

For example, the rear cross frame 300R of the front battery cell assembly structure 60F may be coupled to the front cross frame 300F of the rear battery cell assembly structure 60R.

For example, the cross rack 330 of the front battery cell assembly structure 60F may be coupled to the cross bottom 320 of the rear battery cell assembly structure 60R.

For example, the cross rack 330 of the front battery cell assembly structure 60F may be located above the cross bottom 320 of the rear battery cell assembly structure 60R.

For example, the bottom rack fastening part 342 may be sequentially inserted into the cross rack bottom fastening hole 333 of the front battery cell assembly structure 60F and the cross bottom rack fastening hole 323 of the rear battery cell assembly structure 60R.

A process of coupling the front battery cell assembly structure 60F to the lateral side frames 200L1 and 200L2 may be substantially the same as a process of coupling the rear battery cell assembly structure 60R to the lateral side frames 200L1 and 200L2.

A process of coupling the front battery cell assembly structure 60F to the bottom frame 100 may be substantially the same as a process of coupling the rear battery cell assembly structure 60R to the bottom frame 100.

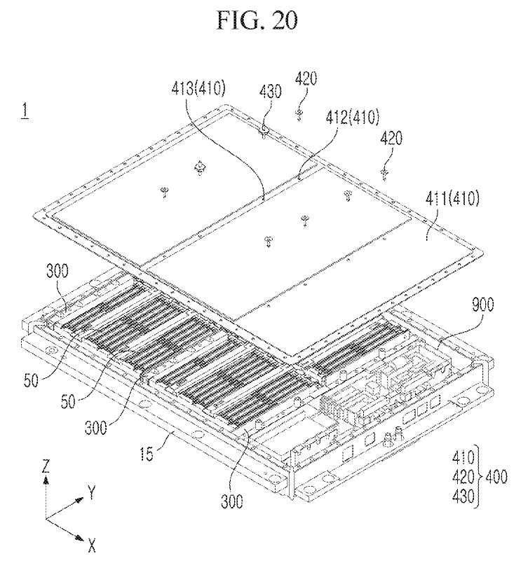

If another battery cell assembly structure 60 is not disposed in front of the front battery cell assembly structure 60F, a member for coupling or connecting a front end portion of the front battery cell assembly structure 60F to the top plate 410 (see FIG. 20) may be required.

For example, the cross frame 300 may include a cross top support link 360. The cross top support link 360 may perform some of the same functions as the cross rack 330.

For example, if another battery cell assembly structure 60 is not disposed in front of the front battery cell assembly structure 60F, the cross top support link 360 may be disposed above the cross bottom 320 of the front battery cell assembly structure 60F.

If another battery cell assembly structure 60 is not disposed in front of the front battery cell assembly structure 60F, a space may be formed between the front battery cell assembly structure 60F and the front side frame 200F. For example, an electrical component 900 (see FIG. 20) may be located in the space between the front battery cell assembly structure 60F and the front side frame 200F.

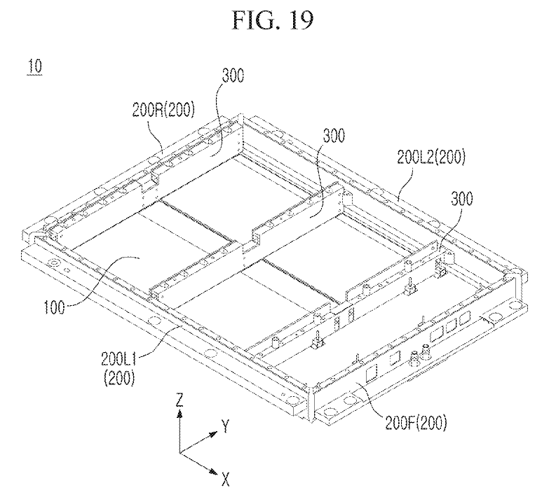

FIG. 19 is a perspective view illustrating the pack frame of the battery pack shown in FIG. 18.

Referring to FIGS. 1 -19, the battery pack 1 may include the pack frame base 15 and the battery cell assembly structure 60. The cross frame 300 of the battery cell assembly structure 60 may be coupled to the pack frame base 15.

For example, a pack frame 10 may include the pack frame base 15 and the cross frame 300. For example, the battery pack 1 may include the pack frame 10 and the battery cell assembly 50.

For example, at least one battery cell assembly 50 may be accommodated or mounted on the pack frame 10. For example, the battery cell assembly 50 may be mounted on the pack frame 10 while the battery cell assembly 50 is not fastened to the cross frame 300.

For example, a process of assembling the battery pack 1 may be divided into two types.

For example, a “first battery pack assembly process” refers to a process of assembling the battery pack 1 and may include a step (process) of mounting the battery cell assembly structure 60 on the pack frame base 15.

For example, the first battery pack assembly process may include a step (process) of coupling the battery cell assembly 50 to the cross frame 300 to form the battery cell assembly structure 60; a step (process) of coupling the battery cell assembly structure 60 to the pack frame base 15; and a step (process) of coupling a top frame 400 to the cross frame 300.

For example, a “second battery pack assembly process” refers to a process of assembling the battery pack 1 and may include a step (process) of mounting the battery cell assembly 50 on the pack frame 10.

For example, the second battery pack assembly process may include a step (process) of coupling the cross frame 300 to the pack frame base 15 to form the pack frame 10; a step (process) of coupling the battery cell assembly 50 to the pack frame 10; and a step (process) of coupling the top frame 400 to the cross frame 300.

For example, in the battery pack 1 assembled through the first battery pack assembly process, the battery cell 500 may be a pouch-type battery cell. For example, the battery cell 500, which is a pouch-type battery cell, may be included in the battery cell assembly 50 to form the battery cell assembly structure 60, and the battery cell assembly structure 60 may be coupled to the pack frame base 15.

For example, in the battery pack 1 assembled through the second battery pack assembly process, the battery cell 500 may be a prismatic battery cell or a cylindrical battery cell. For example, the cross frame 300 may be coupled to the pack frame base 15 to form the pack frame 10, and the battery cell 500 may be included in the battery cell assembly 50 and coupled or accommodated in the pack frame 10.

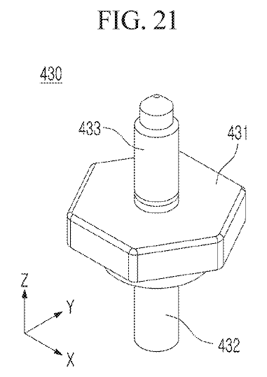

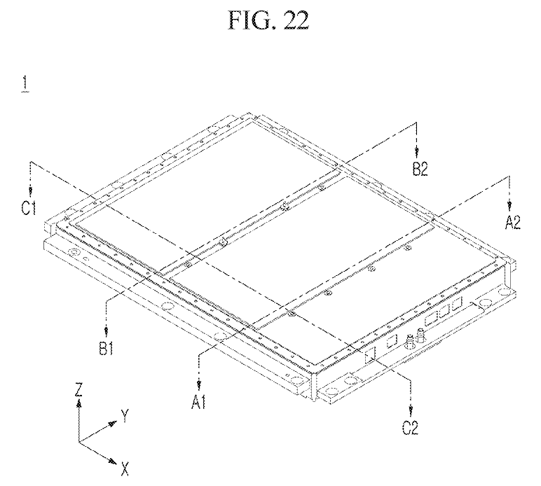

FIG. 20 is an exploded perspective view illustrating the top frame added to the pack frame shown in FIG. 18. FIG. 21 is a perspective view illustrating the top bracket coupler shown in FIG. 20. FIG. 22 is a perspective view illustrating the battery pack shown in FIG. 20 in an assembled state.

Referring to FIGS. 20 -22, the pack frame 10 may include the top frame 400. The top frame 400 may include a top plate 410. The top plate 410 may include a top plate body 411.

The top plate body 411 may have a plate or board shape. For example, the top plate body 411 may define an upper face of the battery pack 1. For example, the top plate body 411 may define an upper face of the pack frame 10.

For example, the top plate body 411 may cover the pack frame base 15. For example, the top plate body 411 may cover the cross frame 300. For example, the top plate body 411 may cover the battery cell assembly 50.

For example, the top plate body 411 may be coupled to the cross frame 300. For example, the top plate 410 may include a top rack fastening hole 412.

For example, the top rack fastening hole 412 may be a hole formed in the top plate body 411. For example, the top rack fastening hole 412 may be a hole that penetrates the top plate body 411 in the vertical direction.

For example, the top frame 400 may include a top rack coupler 420. The top rack coupler 420 may have a bolt shape. For example, the top rack coupler 420 may be inserted into the top rack fastening hole 412 and coupled to the cross rack 330 (see FIGS. 14 and 15).

For example, the top rack coupler 420 may pass through the top rack fastening hole 412 and then be inserted into the cross rack top fastening hole 332 (see FIGS. 14 and 15) and coupled to the cross rack 330 (see FIGS. 14 and 15).

For example, the top plate body 411 may be coupled or fixed to a bracket (not shown) located above the battery pack 1. The bracket (not shown) located above the battery pack 1 may be, for example, a vehicle body. For example, the top plate 410 may include a bracket fastening hole 413.

For example, the bracket fastening hole 413 may be a hole formed in the top plate body 411. For example, the bracket fastening hole 413 may be a hole that penetrates the top plate body 411 in the vertical direction.

For example, the top frame 400 may include a top bracket coupler 430. The top bracket coupler 430 may couple the top plate 410 to the bracket (not shown).

For example, the top bracket coupler 430 may include a top bracket coupler wing 431. At least a portion of the top bracket coupler wing 431 may be accommodated or located in the bracket fastening hole 413.

For example, the top bracket coupler 430 may include a top bracket coupler leg 432. The top bracket coupler leg 432 may be connected or coupled to the top bracket coupler wing 431.

For example, the top bracket coupler leg 432 may protrude downward from a lower face of the top bracket coupler wing 431. For example, the top bracket coupler leg 432 may be fastened to the cross rack 330 (see FIGS. 14 and 15).

For example, the top bracket coupler leg 432 may be inserted into the cross rack top fastening hole 332 (see FIGS. 14 and 15) and fastened thereto. The cross rack top fastening hole 332 (see FIGS. 14 and 15) that is coupled to the top bracket coupler leg 432 may have an inner diameter different from that of the cross rack top fastening hole 332 (see FIGS. 14 and 15) that is coupled to the top rack coupler 420.

For example, the inner diameter of the cross rack top fastening hole 332 (see FIGS. 14 and 15) that is coupled to the top bracket coupler leg 432 may be larger than the inner diameter of the cross rack top fastening hole 332 (see FIGS. 14 and 15) that is coupled to the top rack coupler 420.

For example, the top bracket coupler 430 may include a top bracket coupler head 433. The top bracket coupler head 433 may be connected or coupled to the top bracket coupler wing 431.

For example, the top bracket coupler head 433 may protrude upward from an upper face of the top bracket coupler wing 431. For example, the top bracket coupler head 433 may be coupled or fixed to the bracket (not shown).

The battery pack 1 may include the electrical component 900. The electrical component 900 may be located in a space between the plurality of battery cell assembly structures 60 (see FIG. 18) and the side frame 200.

For example, the electrical component 900 may be located in a space formed between the frontmost cross frame 300 among the plurality of cross frames 300 and the front side frame 200F. The electrical component 900 may be located, for example, in the space between the front battery cell assembly structure 60F and the front side frame 200F.

The electrical component 900 may obtain information about the battery cell 500 from the busbar assembly 700. For example, the electrical component 900 may obtain information regarding at least one of the voltage, current, and temperature of the battery cell 500.

The electrical component 900 may include a battery management system (BMS) that manages the charging and discharging of the battery cell 500. For example, the electrical component 900 may control the battery cell 500 based on the information regarding the battery cell 500 and input signals.

For example, the BMS included in the electrical component 900 may be electrically connected to the battery cell assembly 50. For example, the BMS of the electrical component 900 may be electrically connected to the busbar assembly 700.

For example, the battery cell assembly 50 may be electrically connected to an external power source (not shown) through the electrical component 900. Accordingly, the battery cell 500 may be charged. For example, the BMS included in the electrical component 900 may control the charging of the battery cell 500.

For example, the battery cell assembly 50 may be electrically connected to an external load through the electrical component 900. Accordingly, the battery cell 500 may be discharged. For example, the BMS included in the electrical component 900 may control the discharging of the battery cell 500.

The electrical component 900 may control the temperature of the battery cell 500. For example, the electrical component 900 may control the flow of coolant into and out of the cooling plate 110 (see FIG. 19) based on the information regarding the battery cell 500 and input signals.

For example, the electrical component 900 may control the flow rate of the coolant into and out of the cooling plate 110 (see FIG. 19). For example, the electrical component 900 may include a pump (not shown) that injects coolant into the cooling plate 110 (see FIG. 19) or discharges coolant from the cooling plate 110 (see FIG. 19).

For example, the electrical component 900 may control the temperature of the coolant flowing into the cooling plate 110 (see FIG. 19). For example, the electrical component 900 may include a cooler that cools the coolant flowing into the cooling plate 110 (see FIG. 19).

The pump (not shown) may be connected to at least one of the coolant inlet port 114 (see FIGS. 4 and 5) and the coolant outlet port 115 (see FIGS. 4 and 5). The cooler (not shown) may be connected to the pump (not shown). The BMS (not shown) may control the pump (not shown) and the cooler (not shown).

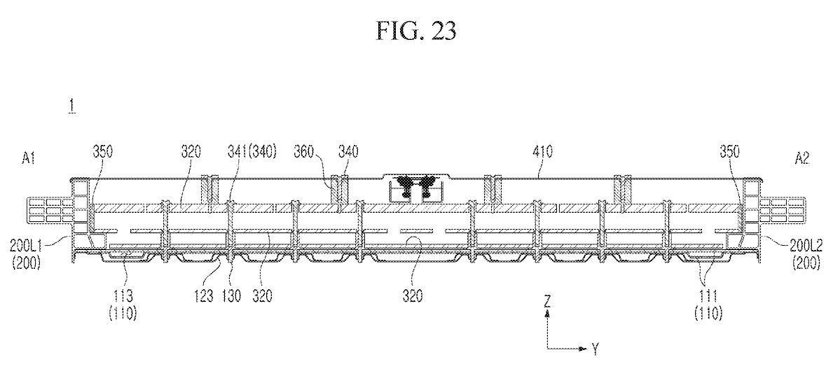

FIG. 23 is a cross-sectional view of the battery pack shown in FIG. 22 taken along line A1-A2.

Referring to FIGS. 1 -23, the cross top support link 360 may be located above the cross bottom 320 of the front battery cell assembly structure 60F.

For example, an upper portion of the cross top support link 360 may be located above the cross bottom 320 of the front battery cell assembly structure 60F.

A shape of the upper portion of the cross top support link 360 may be similar to the shape of the stud head 133. For example, the upper portion of the cross top support link 360 may form a hollow portion that is open upward.

For example, threads may be formed in the hollow portion defined in the upper portion of the cross top support link 360. For example, the hollow portion formed in the upper portion of the cross top support link 360 may be located below the top rack fastening hole 412.

For example, the hollow portion formed in the upper portion of the cross top support link 360 may be in communication with the top rack fastening hole 412. For example, the top rack coupler 420 may be fastened to the cross top support link 360 by passing through the top rack fastening hole 412.

A lower portion of the cross top support link 360 may protrude downward from the upper portion of the cross top support link 360. For example, the lower portion of the cross top support link 360 may be inserted into the cross bottom rack fastening hole 323 and located therein.

Accordingly, the cross bottom 320 of the front battery cell assembly structure 60F may support the top plate body 411 through the cross top support link 360.

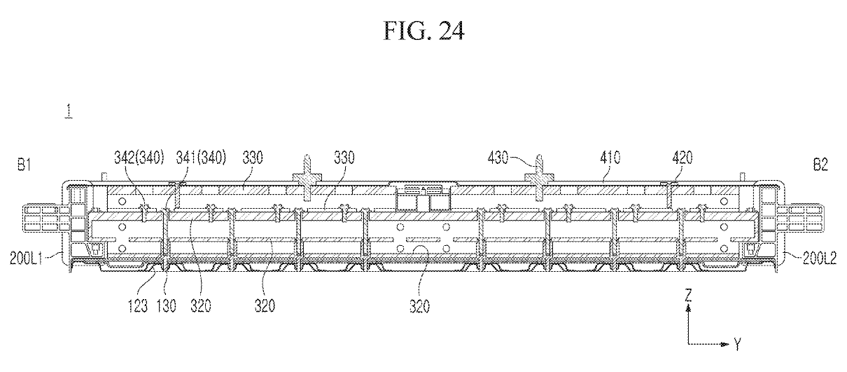

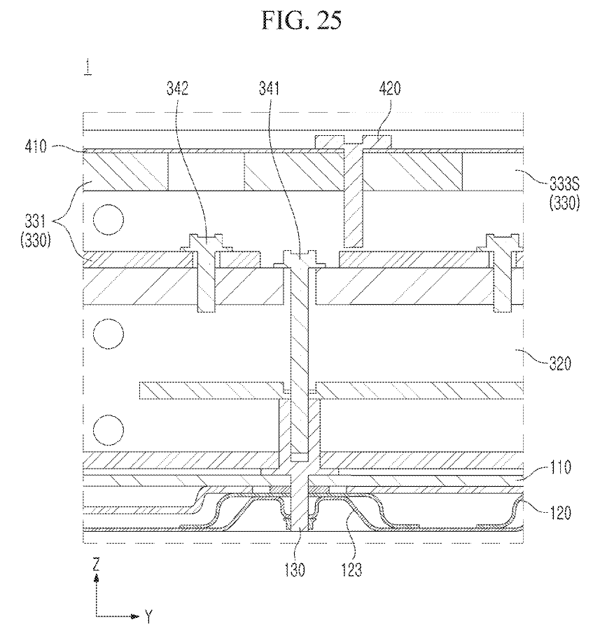

FIG. 24 is a cross-sectional view of the battery pack shown in FIG. 22 taken along line B1-B2. FIG. 25 is an enlarged cross-sectional view of a portion of the battery pack shown in FIG. 24.

Referring to FIGS. 1 -25, the stud head 133 may be inserted into the cross bottom stud fastening hole 322. The stud head 133 may be inserted into a lower end of the cross bottom stud fastening hole 322. For example, the stud head 133 may be inserted into the cross bottom stud fastening hole 322 from below the cross bottom body 321.

For example, an upper end portion of the stud head 133 may be located inside the cross bottom body 321. For example, the stud head 133 may be located below an upper end of the cross bottom stud fastening hole 322.

For example, the stud bottom fastening part 341 may couple the cross bottom 320 and the cooling plate 110. For example, the stud bottom fastening part 341 may be inserted into the upper end of the cross bottom stud fastening hole 322 and into the stud head 133. For example, the lower end portion of the stud bottom fastening part 341 may be inserted into the stud head 133 and coupled thereto.

For example, the cross rack bottom fastening hole 333 may be located above the cross bottom rack fastening hole 323. For example, the bottom rack fastening part 342 may be inserted into the cross rack bottom fastening hole 333 from above the cross rack bottom fastening hole 333.

The bottom rack fastening part 342 inserted into the cross rack bottom fastening hole 333 may be inserted into the cross bottom rack fastening hole 323 and coupled thereto. For example, the bottom rack fastening part 342 coupled to the cross bottom rack fastening hole 323 may be located in the cross rack working space 333S or below the cross rack working space 333S.

Accordingly, the cross bottom 320 and the cross rack 330 may be coupled to each other through the bottom rack fastening part 342.

For example, the bottom rack fastening part 342 may connect or couple the rear battery cell assembly structure 60R and the front battery cell assembly structure 60F.

For example, the bottom rack fastening part 342 may connect or couple the front cross frame 300F of the rear battery cell assembly structure 60R and the rear cross frame 300R of the front battery cell assembly structure 60F.

For example, the bottom rack fastening part 342 may connect or couple the cross bottom 320 of the rear battery cell assembly structure 60R and the cross rack 330 of the front battery cell assembly structure 60F.

The top rack coupler 420 may be inserted into the top plate body 411 and coupled to the cross rack 330. For example, a portion of the top rack coupler 420 may penetrate the top plate body 411 and be inserted into the cross rack top fastening hole 332. For example, the lower end portion of the top rack coupler 420 may be inserted into the cross rack top fastening hole 332 and fastened thereto.

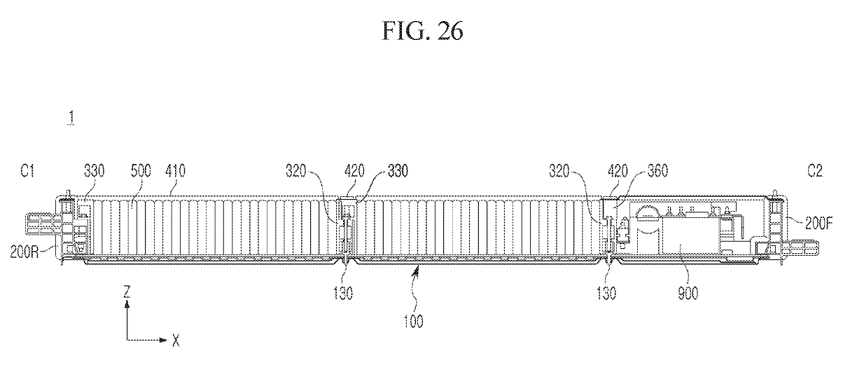

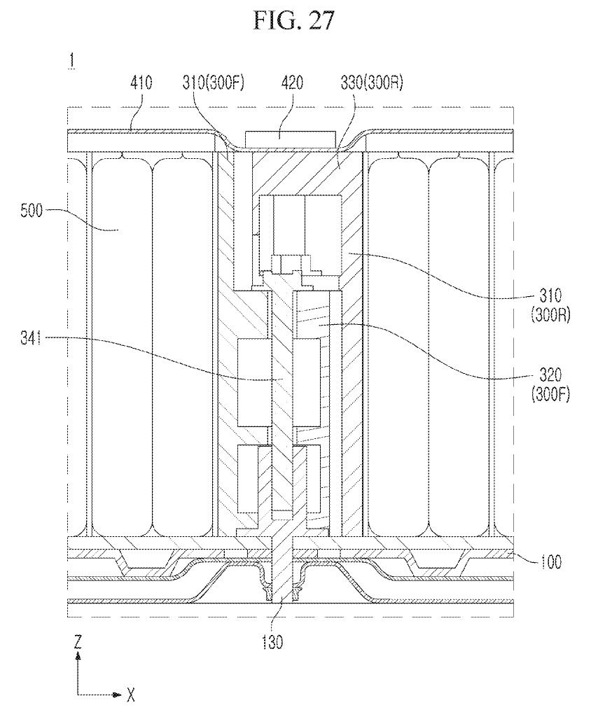

FIG. 26 is a cross-sectional view of the battery pack shown in FIG. 22 taken along line C1-C2. FIG. 27 is an enlarged cross-sectional view of a portion of the battery pack shown in FIG. 26.

Referring to FIGS. 1 to 27, some of the plurality of top rack couplers 420 may be coupled to the cross rack 330, and the remaining top rack couplers 420 may be coupled to the cross top support link 360.

For example, some of the plurality of top rack couplers 420 may be coupled to the cross rack 330 of the front battery cell assembly structure 60F, and the remaining top rack couplers 420 may be coupled to the cross top support link 360.

The cross top support link 360 may perform a function similar to the cross rack 330. For example, the cross top support link 360 may support the top plate body 411. For example, at least one cross top support link 360 may be replaced by the rear cross frame 300R including the cross rack 330.

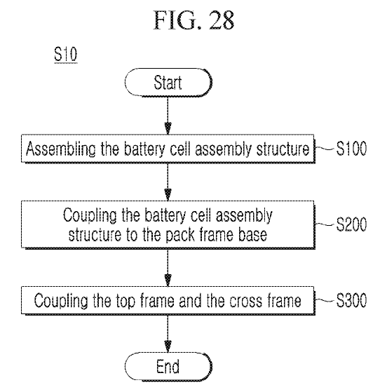

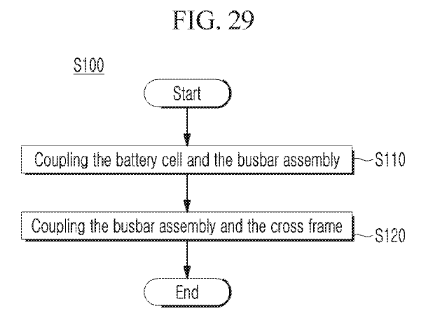

FIG. 28 is a flowchart illustrating a first battery pack assembly method according to an embodiment of the present disclosure. FIG. 29 is a flowchart illustrating a method for assembling the battery cell assembly structure shown in FIG. 28.

Referring to FIGS. 1 -29, a first battery pack assembly process (S10) or a first battery pack assembly method (S10) may include a battery cell assembly structure assembling step (S100). This step (S100) may be referred to as the “method for assembling the battery cell assembly structure.”

In the battery cell assembly structure assembling step (S100), the battery cell assembly structure 60 may be assembled. For example, in this step (S100), at least one battery cell 500, the busbar assembly 700, and the cross frame 300 may be coupled to each other to form the battery cell assembly structure 60.

The battery cell assembly structure assembling step (S100) may include a step (S110) of coupling at least one battery cell 500 and the busbar assembly 700.

In this step (S110), the busbar 700B may be electrically connected to the battery cell 500. In this step (S110), the busbar support base 700SB may be located below at least one battery cell 500 and may support the at least one battery cell 500.

The battery cell assembly structure assembling step (S100) may include a step (S120) of coupling the cross frame 300 and the busbar assembly 700 to each other.

In this step (S120), the cross frame 300 may be coupled to the busbar assembly 700. For example, in this step (S120), the cross frame 300 may be coupled to the busbar support coupler 700SC.

The first battery pack assembly method (S10) may include a step (S200) of coupling at least one battery cell assembly structure 60 to the pack frame base 15.

In this step (S200), among the plurality of battery cell assembly structures 60, the battery cell assembly structure 60 located relatively rearward may be coupled to the pack frame base 15 prior to coupling the battery cell assembly structure 60 located relatively forward to the pack frame base 15.

For example, in this step (S200), the rear battery cell assembly structure 60R may be coupled to the pack frame base 15, and thereafter the front battery cell assembly structure 60F may be coupled to the pack frame base 15.

In this step (S200), for example, the rear cross frame 300R of the rear battery cell assembly structure 60R may be coupled to the rear side frame 200R.

In this step (S200), for example, the rear cross frame 300R of the front battery cell assembly structure 60F may be coupled to the front cross frame 300F of the rear battery cell assembly structure 60R.

The first battery pack assembly method (S10) may include a step (S300) of coupling the top frame 400 and the cross frame 300. In this step (S300), the top rack coupler 420 may couple the top plate body 411 and the cross rack 330. In this step (S300), the top rack coupler 420 may couple the top plate body 411 and the cross top support link 360.

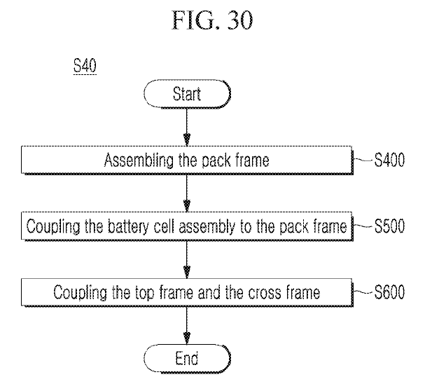

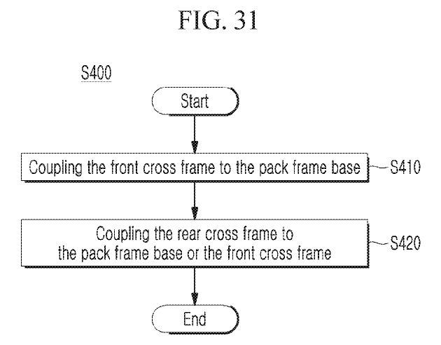

FIG. 30 is a flowchart illustrating a second battery pack assembly method according to an embodiment of the present disclosure. FIG. 31 is a flowchart illustrating a method for assembling the pack frame shown in FIG. 30.

Referring to FIGS. 1 -27, 30, and 31, a second battery pack assembly process (S40) or a second battery pack assembly method (S40) may include a step (S400) of assembling the pack frame 10. For example, in the step (S400) of assembling the pack frame 10, at least one cross frame 300 may be coupled to the pack frame base 15.

The step (S400) of assembling the pack frame 10 may include a step (S410) of coupling the front cross frame 300F to the pack frame base 15.

At this step (S410), at least one front cross frame 300F may be coupled to the pack frame base 15. At this step (S410), when a plurality of front cross frames 300F are provided, the plurality of front cross frames 300F may be sequentially arranged while being spaced apart from each other in the front-rear direction.

At this step (S410), the stud bottom fastening part 341 may be fastened to the stud 130 to couple the cross bottom 320 of the front cross frame 300F to the cooling plate 110.

At this step (S410), the cross side fastening part 343 may couple the cross side coupler 350 of the front cross frame 300F to the lateral side frames 200L1 and 200L2.

The step (S400) of assembling the pack frame 10 may include a step (S420) of coupling at least one rear cross frame 300R to the pack frame base or to the front cross frame.

In this step (S420), at least one rear cross frame 300R may be coupled to the rear side frame 200R or to the cross bottom 320 of the front cross frame 300F.

For example, in this step (S420), the bottom rack fastening part 342 may couple the cross rack 330 of the rear cross frame 300R to the rear side frame 200R.

For example, in this step (S420), the bottom rack fastening part 342 may couple the cross rack 330 of the rear cross frame 300R to the cross bottom 320 of the front cross frame 300F.

The second battery pack assembly method (S40) may include a step (S500) of coupling the battery cell assembly 50 to the pack frame 10. In this step (S500), at least one battery cell assembly 50 may be mounted on the pack frame 10.

The second battery pack assembly method (S40) may include a step (S600) of coupling the top frame 400 and the cross frame 300. This step (S600) may be substantially similar to the step (S300) of coupling the top frame 400 and the cross frame 300 in the first battery pack assembly method (S10, see FIG. 28).

For example, in this step (S600), the top rack coupler 420 may couple the top plate body 411 and the cross rack 330. In this step (S600), the top rack coupler 420 may couple the top plate body 411 and the cross top support link 360.

Referring to FIGS. 1 -31, the pack frame base 15 may include the bottom frame 100 including the bottom plates 110 and 120 that define the lower face, and the stud 130 coupled to the bottom plates 110 and 120.

The pack frame base 15 may include the side frame 200 protruding upward from at least a portion of a periphery of the bottom plates 110 and 120.

The stud 130 may include: the stud wing 131 having a lower face that faces and contacts the bottom plates 110 and 120; the stud leg 132 extending downward from the lower face of the stud wing 131 and coupled to the bottom plates 110 and 120; and the stud head 133 protruding upward from the upper face of the stud wing 131.

The bottom plates 110 and 120 may include: the bottom plate bodies 111 and 121 that define the lower face of the bottom frame 100; and the bottom plate stud holes 112 and 122 that are formed in a recessed shape in the upper faces of the bottom plate bodies 111 and 121.

The stud leg 132 may be inserted into the bottom plate stud holes 112 and 122 and fastened thereto.

The side frame 200 may include: the side stand 210 protruding from the bottom plates 110 and 120; and the side wall 220 extending from the upper face of the side stand 210 and forming a step.

The pack frame base 15 may include, as the side frame 200, the rear side frame 200R protruding upward from the rear end portion of the bottom plates 110 and 120.

The pack frame base 15 may include, as the side frame 200, the first side frame 200L1 extending forward from a first end of the rear end portion of the bottom plates 110 and 120.

The pack frame base 15 may include, as the side frame 200, the second side frame 200L2 extending forward from a second end of the rear end portion of the bottom plates 110 and 120.

The bottom plates 110 and 120 may include the cooling plate 110 including the cooling plate body 111 that defines the upper face of the bottom plates 110 and 120 and the cooling channel 113 formed in the cooling plate body 111.

The bottom plates 110 and 120 may include the protective plate 120 including the protective plate body 121 located below the cooling plate body 111.

The cooling plate 110 may include the cooling plate stud hole 112 formed in the cooling plate body 111 and extending vertically therethrough, and the protective plate 120 may include the protective plate stud hole 122 formed in the protective plate body 121 and extending vertically therethrough, the protective plate stud hole 122 being located below the cooling plate stud hole 112.

The pack frame base 15 may include the cooling plate stud fastening part 141 located between the cooling plate body 111 and the protective plate body 121 and coupled to the stud leg 132.

The pack frame base 15 may include the protective plate stud fastening part 142 located below the protective plate dome 123 formed in a recessed shape in a lower face of the protective plate body 121 and coupled to the stud leg 132.

The battery cell assembly structure 60 may include: a plurality of battery cells 500 sequentially disposed in the front-rear direction; the front cross frame 300F located in front of the plurality of battery cells 500; the rear cross frame 300R located behind the plurality of battery cells 500; and the busbar units 710 and 720 including the busbar support 700S that connects an end of the front cross frame 300F to an end of the rear cross frame 300R.

The front cross frame 300F may include: a front cross wall 310 having a rear face that faces the frontmost battery cell 500 among the plurality of battery cells 500; and the cross bottom 320 including the cross bottom body 321 that protrudes forward from the front cross wall 310 and has an upper end that is lower than the upper end of the front cross wall 310.

The cross bottom 320 may include the cross bottom stud fastening hole 322 that penetrates the cross bottom body 321 in the vertical direction.

The rear cross frame 300R may include: a rear cross wall 310 having a front face that faces the rearmost battery cell 500 among the plurality of battery cells 500; and the cross rack 330 including the cross rack body 331 that protrudes rearward from the rear cross wall 310 and has a lower end that is higher than the lower end of the rear cross wall 310.

The busbar support 700S may include the busbar support plate 700SP extending in the front-rear direction; and a pair of busbar support couplers 700SC connected to a front end and a rear end of the busbar support plate 700SP.

One of the pair of busbar support couplers 700SC may be coupled to the front cross wall 310, and the other of the pair of busbar support couplers 700SC may be coupled to the rear cross wall 310.

The battery pack 1 according to an embodiment of the present disclosure may include: the battery cell assembly structure 60 including the plurality of battery cells 500 sequentially disposed in the front-rear direction, the front cross frame 300F located in front of the plurality of battery cells 500, and the rear cross frame 300R located behind the plurality of battery cells 500; the bottom frame 100 including the bottom plates 110 and 120 on which the plurality of battery cells 500 are mounted, and the stud 130 coupled to the bottom plates 110 and 120; and the side frame 200 protruding upward from at least a portion of the periphery of the bottom plates 110 and 120, wherein the stud 130 may protrude upward from the bottom plates 110 and 120 and be coupled to the battery cell assembly structure 60.

The stud 130 may include the stud wing 131 having a lower face that faces and contacts the bottom plates 110 and 120; the stud leg 132 extending downward from the lower face of the stud wing 131 and coupled to the bottom plates 110 and 120; and the stud head 133 protruding upward from the upper face of the stud wing 131 and coupled to the front cross frame 300F.

The front cross frame 300F may include: the front cross wall 310 having a rear face that faces the frontmost battery cell 500 among the plurality of battery cells 500; and the cross bottom 320 including the cross bottom body 321 that protrudes forward from the front cross wall 310 and has an upper end that is lower than the upper end of the front cross wall 310, wherein the stud head 133 may be coupled to the cross bottom 320.

The rear cross frame 300R may include: the rear cross wall 310 having a front face that faces the rearmost battery cell 500 among the plurality of battery cells 500; and the cross rack 330 including the cross rack body 331 that protrudes rearward from the rear cross wall 310 and has a lower end that is higher than the upper end of the cross bottom body 321.

The battery pack 1 may include, as the battery cell assembly structure 60, the rear battery cell assembly structure 60R and the front battery cell assembly structure 60F sequentially disposed from rear to front, wherein the cross rack 330 of the front battery cell assembly structure 60F may be located above and coupled to the cross bottom 320 of the rear battery cell assembly structure 60R.

The battery pack 1 may include, as the side frame 200, the rear side frame 200R protruding upward from the rear end portion of the bottom plates 110 and 120.

The battery pack 1 may include, as the side frame 200, the first side frame 200L1 extending forward from the first end of the rear end portion of the bottom plates 110 and 120.

The battery pack 1 may include, as the side frame 200, the second side frame 200L2 extending forward from the second end of the rear end portion of the bottom plates 110 and 120.

The cross rack body 331 of the rear battery cell assembly structure 60R may be coupled to the rear side frame 200R.

The side frame 200 may include: the side stand 210 protruding from the bottom plates 110 and 120; and the side wall 220 extending from the upper face of the side stand 210 and forming a step.

The cross rack body 331 of the rear battery cell assembly structure 60R may be coupled to the side stand 210 of the rear side frame 200R.

The contents described above are merely examples of applying the principles of the present disclosure, and other configurations may be further included without departing from the scope of the present disclosure.

What is claimed is:

1. A pack frame base comprising:
a bottom frame comprising a bottom plate that defines a lower face and a stud coupled to the bottom plate; and
a side frame protruding upward from at least a portion of a periphery of the bottom frame,
wherein the stud comprises:
a stud wing having a lower face that faces and contacts the bottom plate;
a stud leg extending downward from the lower face of the stud wing and coupled to the bottom plate; and
a stud head protruding upward from an upper face of the stud wing.

2. The pack frame base according to claim 1, wherein the bottom plate comprises:
a bottom plate body that defines a lower face of the bottom frame; and
a bottom plate stud hole formed in a recessed shape in an upper face of the bottom plate body.

3. The pack frame base according to claim 2, wherein the stud leg is inserted into the bottom plate stud hole and fastened thereto.

4. The pack frame base according to claim 1, wherein the side frame comprises:
a side stand protruding from the bottom plate; and
a side wall extending from an upper face of the side stand and forming a step.

5. The pack frame base according to claim 4, wherein the side frame comprises:
a rear side frame protruding upward from a rear end portion of the bottom plate;
a first side frame extending forward from a first end of the rear end portion of the bottom plate; and
a second side frame extending forward from a second end of the rear end portion of the bottom plate.

6. The pack frame base according to claim 1, wherein the bottom plate comprises:
a cooling plate comprising a cooling plate body that defines the upper face of the bottom plate and a cooling channel formed in the cooling plate body; and
a protective plate including a protective plate body located below the cooling plate body.

7. The pack frame base according to claim 6, wherein the cooling plate comprises a cooling plate stud hole formed in the cooling plate body and extending vertically therethrough, and
wherein the protective plate comprises a protective plate stud hole formed in the protective plate body and extending vertically therethrough, the protective plate stud hole being located below the cooling plate stud hole.

8. The pack frame base according to claim 7, wherein the bottom plate further comprises:
a cooling plate stud fastening part located between the cooling plate body and the protective plate body and coupled to the stud leg; and
a protective plate stud fastening part located below a protective plate dome formed in a recessed shape in a lower face of the protective plate body and coupled to the stud leg.

9. A battery cell assembly structure comprising:
a plurality of battery cells sequentially disposed in a front-rear direction;
a front cross frame located in front of the plurality of battery cells;
a rear cross frame located behind the plurality of battery cells; and
a busbar unit comprising a busbar support that connects an end of the front cross frame to an end of the rear cross frame.

10. The battery cell assembly structure according to claim 9, wherein the front cross frame comprises:
a front cross wall having a rear face that faces the frontmost battery cell among the plurality of battery cells; and
a cross bottom comprising a cross bottom body protruding forward from the front cross wall and having an upper end that is lower than the upper end of the front cross wall.

11. The battery cell assembly structure according to claim 10, wherein the cross bottom comprises a cross bottom stud fastening hole extending vertically through the cross bottom body.

12. The battery cell assembly structure according to claim 10, wherein the rear cross frame comprises:
a rear cross wall having a front face that faces the rearmost battery cell among the plurality of battery cells; and
a cross rack comprising a cross rack body that protrudes rearward from the rear cross wall and has a lower end that is higher than the lower end of the rear cross wall.

13. The battery cell assembly structure according to claim 12, wherein the busbar support comprises:
a busbar support plate having a shape extending in the front-rear direction; and
a pair of busbar support couplers connected to a front end and a rear end of the busbar support plate,
wherein one of the pair of busbar support couplers is coupled to the front cross wall, and
the other of the pair of busbar support couplers is coupled to the rear cross wall.

14. A battery pack comprising:
a battery cell assembly structure comprising a plurality of battery cells sequentially disposed in a front-rear direction, a front cross frame located in front of the plurality of battery cells, and a rear cross frame located behind the plurality of battery cells;
a bottom frame comprising a bottom plate on which the plurality of battery cells are mounted and a stud coupled to the bottom plate; and
a side frame protruding upward from at least a portion of a periphery of the bottom plate;
wherein the stud protrudes upward from the bottom plate and is coupled to the battery cell assembly structure.

15. The battery pack according to claim 14, wherein the stud comprises:
a stud wing having a lower face that faces and contacts the bottom plate;
a stud leg extending downward from the lower face of the stud wing and coupled to the bottom plate; and
a stud head protruding upward from an upper face of the stud wing and coupled to the front cross frame.

16. The battery pack according to claim 15, wherein the front cross frame comprises:
a front cross wall having a rear face that faces the frontmost battery cell among the plurality of battery cells; and
a cross bottom comprising a cross bottom body protruding forward from the front cross wall and having an upper end that is lower than the upper end of the front cross wall,
wherein the stud head is coupled to the cross bottom.

17. The battery pack according to claim 16, wherein the rear cross frame comprises:
a rear cross wall having a front face that faces the rearmost battery cell among the plurality of battery cells; and
a cross rack comprising a cross rack body that protrudes rearward from the rear cross wall and has a lower end that is higher than the upper end of the cross bottom body.

18. The battery pack according to claim 17, further comprising, as the battery cell assembly structure, a rear battery cell assembly structure and a front battery cell assembly structure sequentially disposed from rear to front, and
wherein the cross rack of the front battery cell assembly structure is located above and coupled to the cross bottom of the rear battery cell assembly structure.

19. The battery pack according to claim 18, further comprising, as the side frame,
a rear side frame protruding upward from a rear end portion of the bottom plate;
a first side frame extending forward from a first end of the rear end portion of the bottom plate; and
a second side frame extending forward from a second end of the rear end portion of the bottom plate,
wherein the cross rack body of the rear battery cell assembly structure is coupled to the rear side frame.

20. The battery pack according to claim 19, wherein the side frame comprises:
a side stand protruding from the bottom plate; and
a side wall extending from an upper face of the side stand and forming a step,
wherein the cross rack body of the rear battery cell assembly structure is coupled to the side stand of the rear side frame.
